(19) United States
(12) Patent Application Publication
(10) Pub. No.: US 2021/0334322 A1
(43) Pub. Date: Oct. 28, 2021

(54) SYSTEM AND METHOD FOR ONLINE GLOBAL COMMERCE

(71) Applicant: Shop4e Inc., Seattle, WA (US)

(72) Inventors: Haijun HU, Seattle, WA (US); Oleg Borisovich GERSHUNSKIY, Rockville, MD (US)

(73) Assignee: Shop4e Inc., Seattle, WA (US)

(21) Appl. No.: 17/305,587

(22) Filed: Jul. 9, 2021

Related U.S. Application Data
(63) Continuation of application No. 15/992,139, filed on May 29, 2018, now abandoned.
(60) Provisional application No. 62/512,680, filed on May 30, 2017.

(51) Int. Cl. G06F 16/958; G06Q 30/06; G06F 40/40; G06F 16/957; G06F 16/955; G06F 16/951

(52) U.S. Cl. CPC G06F 16/958; G06Q 30/06; G06F 16/951; G06F 16/9577; G06F 16/955; G06F 40/40

(57) ABSTRACT

A system and method for automatically acquiring, manipulating and publishing data includes an input/output module, configured to receive a user query, and an intermediary module, communicably connected to the input/output module. The intermediate module includes a data fetch module, configured to acquire data from a data source based on the user query, a manipulation module, configured to manipulate the data to better suit user query, and a publication module, configured to publish the manipulated data based on the user query.

### CROSS-REFERENCE TO RELATED APPLICATIONS

This application is a continuation of U.S. patent application Ser. No. 15/992,139, filed May 29, 2018, which application claims the benefit under 35 U.S.C. § 119(e) of the priority of U.S. Provisional Patent Application Ser. No. 62/512,680, filed May 30, 2017, the entirety of which is hereby incorporated by reference for all purposes.

### TECHNICAL FIELD

The present disclosure relates to the global sale and purchase of products and, more particularly, to that sale and purchase via the Internet.

### BACKGROUND

In times of globalization, companies desire to sell products in all geographic markets via the Internet. However, for various reasons, including differences in language and currency, government regulations and prohibitions, and problems with logistics and fulfillment, it has not been possible for companies to meet their desire to sell products online worldwide.

### SUMMARY OF THE INVENTION

According to an objective of the invention, there is provided a system for acquiring, manipulating and publishing data. The system includes an input/output module to receive a user query. The system may further include an intermediary module communicably connected to the input/output module. The intermediary module may further include a data fetch module to acquire data from a data source based on the user query. The intermediary module further includes a manipulation module, configured to manipulate the data in order to suit better to the user query. Intermediary module also includes a publication module, which publishes the manipulated data.

According to another objective of the invention, there is provided a method for acquiring, manipulating and publishing a data. The method may include the step of receiving a user query based on which data is acquired. The method may further include manipulating the data acquired to suit better to the user query, and publishing of the manipulated data for the user.

According to yet another objective of the invention, there is provided a system for automatically translating information. The system includes a first server, configured to store information in a first format. The system further includes a second server, which is communicably connected to the first server, wherein the second server includes an input/output module, configured to display a user input receiving screen to the user to request for the information, wherein the user understands a second format. The second server also includes a hosting module, configured to host the input/output module; and a translation module, communicably connected to the hosting module and configured to receive the user input, wherein the translation module is configured to translate the information from the first format to the second format in real-time based on the user input, wherein further, the layout of the translated information is substantially analogous to the information.

Another objective of the invention is to provide a method for automatically translating information that includes receiving a user input, on an input screen, to access an information, wherein the information is stored on a first server in a first format; translating, by a translation module, the information to a second format understandable to the user; providing an address, by a hosting module, to the information in second format; and displaying, by the hosting module, the information in second format, wherein layout of the information in second format is substantially analogous to information in first format.

According to yet another objective of the invention, there is provided a dynamically customizable platform for ecommerce including; an ecommerce website content, wherein an ecommerce website content is hosted on a first server hosted in a first country; a mediation server, wherein the mediation server is communicably connected to the first server, wherein the mediation server is further configured to receive a request for a content, from a user in a second country, present on the ecommerce website content, the meditation server further includes; a translation module, wherein the translation module is configured to translate content of the ecommerce website content as and when request is generated by the user to access the ecommerce website content; and a hosting module, wherein the hosting module is configured to host the translated content through a local website content, wherein address of corresponding local website content is different from that of the ecommerce website content.

Another objective of the present invention is a method for dynamically customizing ecommerce including the steps of; receiving, by a mediation server, a request to access an ecommerce website content hosted on a first server in a first country generated from a user in a second country; translating, by a translation module, content of the ecommerce website content as and when accessed by the user; hosting, by a hosting module, the translated content of the ecommerce website content through a substantially analogous local website content, wherein the address of the corresponding website content is different from that of the ecommerce website content; and displaying, it to the user on a display device.

According to yet another objective of the invention, there is provided a system for automated educational purpose, system including; a host server, configured to store educational information in a first format; a local server, communicably connected to the host server, configured to publish the educational information, wherein the local server further includes; a caching module, configured to fetch the educational information from the host server and store it as cached educational information; an input/output module, configured to receive a user query; a cache checking module, configured to check consistency between the educational information and the cached educational information, wherein any change done in the educational information is automatically reflected in the cached educational information; and a publication module, configured to publish the cached educational information based on the user query.

The invention also provides a method for automated education including steps of; fetching, by a caching module of a local server, an educational information stored in a host server in a first format, communicably connected to the local server, to be stored as cached educational information; checking, by a cache checking module of the local server, consistency between the educational information and the cached educational information, wherein any change done in the educational information is automatically reflected in the cached educational information; and publishing, by a publication module of the local server, the cached educational information based on a user query.

According to yet another objective of the invention, there is provided a system for automated information publishing including; a host server, configured to store information in a first format; a local server, communicably connected to the host server, configured to publish the information, wherein the local server further includes: a caching module, configured to fetch the information from the host server and store it as cached information; an input/output module, configured to receive a user query; a cache checking module, configured to check consistency between the information and the cached information, wherein any change done in the information is automatically reflected in the cached information; and a publication module, configured to publish the cached information based on the user query.

According to yet another objective of the invention there is provided a method for automated information publishing including steps of; fetching, by a caching module of a local server, an information stored in a host server in a first format, communicably connected to the local server, to be stored as cached information; checking, by a cache checking module of the local server, consistency between the information and the cached information, wherein any change done in the information is automatically reflected in the cached information; and publishing, by a publication module of the local server, the cached information based on a user query.

Another objective of the invention is to provide a system for automated shopping including; a host server, configured to store ecommerce website content in a first format; a local server, communicably connected to the host server, configured to publish the ecommerce website content, wherein the local server further includes: a caching module, configured to fetch the ecommerce website content from the host server and store it as cached ecommerce website content; an input/output module, configured to receive a user shopping query; a cache checking module, configured to check consistency between the ecommerce website content and the cached ecommerce website content, wherein any change done in the ecommerce website content is automatically reflected in the cached ecommerce website content; and a publication module, configured to publish the cached ecommerce website content based on the user shopping query.

According to yet another objective of the invention, there is provided a method for automated information shopping including steps of; fetching, by a caching module of a local server, an ecommerce website content stored in a host server in a first format, communicably connected to the local server, to be stored as cached ecommerce website content; checking, by a cache checking module of the local server, consistency between the ecommerce website content and the cached ecommerce website content, wherein any change done in the ecommerce website content is automatically reflected in the cached ecommerce website content; and publishing, by a publication module of the local server, the cached ecommerce website content based on a user shopping query.

According to yet another objective of the invention, there is provided a system for providing products globally including; a first server, hosting a main website content, comprising information of a plurality of products wherein the information of each of the plurality of products is certified in a first format for a first region; a second server, that further includes; a request module, configured to fetch information of at least one product of the plurality of products, based on a user request; a region module, configured to identify region of origin of the user request; a conversion module, configured to convert the information of the at least one product to a second format correspondingly suitable to the region of origin; an intermediary services module, configured to add a plurality of intermediary services to the converted information suitable to the region of origin; and a hosting module, configured to host the converted information on a local website content, wherein corresponding address of the local website content is different from address of main website content and wherein further, the local website content address comprises at least a part of the main website content address.

The invention is also a method for providing products globally including steps of; receiving, by a request module, a user request for information about at least one product available in a main website content hosted on a first server in a first format for a first region; identifying, by a region module, region of origin of the user request; converting, by a conversion module, the information of the at least one product to a second format correspondingly suitable to the region of origin; adding, by an intermediary services module, a plurality of intermediary services to the converted information suitable to the region of origin; and hosting, by a host module, the converted information on a local website content, wherein corresponding address of the local website content is different from address of main website content and wherein further, the local website content address comprises at least a part of the main website content address.

According to yet another objective of the invention, there is provided a system for providing reseller website content services including; a first server, hosting a main website content, for a first region in a first format, a second server, hosting a reseller website content, wherein the reseller website content is configured to host the main website content after performing steps of: acquiring latest copy of the main website content from the first server; translating the latest copy into a second format suitable for a second region, adding the reseller website content services suitable for the second region to the translated latest copy to create a copy website content; and hosting the copy website content at an address different from a corresponding address of the main website content.

According to yet another objective of the invention, there is provided a method for providing reseller website content services including steps of; acquiring, by a local server, the latest copy of a main website content of a first region in a first format from a first server; translating, by the second server, the latest copy of the main website content from the first server, adding the reseller website content services suitable for a second region to the translated latest copy to create a copy website content; and hosting the copy website content on an address different from a corresponding address of the main website content.

Another objective of the invention is to provide a system for providing intermediary website content services, the system includes; a first server, configured to host a website content in a first format for a first region; a second server, communicably connected to the first server, and configured to host a local website content for a second region, wherein the second server is further configured to translate information of the website content into a second format suitable for the second region, wherein the layout of the translated information is substantially analogous to the website content layout; and an intermediary server, communicably connected to the second server, and configured to provide intermediary website content services specific to the second region.

According to yet another objective of the invention, there is provided a method for providing intermediary website content services, method including steps of; accessing, a website content hosted on a first server including information in a first format for a first region; and converting, the information into a second format understandable by a user of a second region, wherein the conversion is performed by providing intermediary website content services wherein the intermediary services comprises any one or a combination of shipment carriers, payment service providers, translation service providers, local sales channel providers, local social networks, or marketing service providers.

According to yet another objective, there is provided a method for ecommerce including steps of; receiving, by an intermediary server, a request for at least one product not available in a country, analyzing, by the intermediary server, the request; identifying, by the intermediary server, a certified source website content of the product based on the request; fetching, by the intermediary server, a copy of the source website content; translating, by the intermediary server, information in the copy of the source website content to a language suitable for the country; initiating, by the intermediary server, a delivery auction process for delivery information of the at least one product including steps of; sending information to affiliate delivery providers; identifying best bids; selecting a best bid for the delivery information; and displaying, by the intermediary server, the copy of the source website content along with the selected bid for delivery information.

The invention is also a sourcing ecommerce method including steps of; receiving, by an intermediary server, a user request for at least one product not available in a country, analyzing, by the intermediary server, the request; identifying, by the intermediary server, a certified source website content of the product based on user's request; fetching, by the intermediary server, a copy of the source website content; and translating, by the intermediary server, information in the copy of the source website content to a language suitable for the country; initiating, by the intermediary server.

The sourcing ecommerce method also includes a delivery auction process for delivery information about the at least one product including steps of; sending information to affiliate delivery providers; identifying best bids; selecting a best bid for the delivery information; receiving, by the intermediary server, an order for the at least one product; sending, by the intermediary server, the order fulfillment request to the source website content; receiving, by the intermediary server, order delivery details from the source website content to an address different from the address of the user, wherein the delivery address corresponds to the affiliate delivery provider with the best bid; and providing, by the intermediary server, a delivery schedule after consideration of the delivery details received from the source website content; and displaying, by the intermediary server, the copy of the source website content along with the delivery information.

According to yet another objective of the invention, there is provided a system for localizing a website content, including; a main web server, wherein the server is configured to host a main website content; a local server, wherein the local server is for a geographically different area from the main web server, the local server comprising; a translation module, wherein the translation module is configured to translate content of the main website content in a language suitable for local area, in real-time; a host module, wherein the host module is configured to host the translated content through a local website content, wherein the address of the corresponding local website content is different from the main website content; and a change checking module, wherein the change checking module is configured to check if there are any changes on the main website content and replicates those changes to the local website content.

According to yet another objective of the invention, there is provided a method for localizing a website content, including steps of; obtaining content of the website content, wherein the website content is hosted on a main server by a first address; translating the content obtained from the website content, into a language specific to a geographical area, hosting the translated content substantially analogous to the content of the website content, wherein the hosting is performed by a local server by a second address, wherein the second address is different from the first address; and displaying, the translated content to a user of the specific geographical area.

### BRIEF DESCRIPTION OF THE FIGURES

The foregoing summary, as well as the following detailed description of various embodiments, is better understood when read in conjunction with the drawings provided herein. For the purpose of illustration, there is shown in the drawings exemplary embodiments; however, the presently disclosed subject matter is not limited to the specific methods and features disclosed.

FIG. 1 is a block diagram of a system 100 for automatically acquiring, manipulating and publishing data, in accordance with a version of the invention.

FIG. 2 is a flow diagram of a method 200 for automatically acquiring, manipulating and publishing data, in accordance with a version of the invention.

FIG. 3 is a block diagram of a system 300 for automatically translating information, in accordance with a version of the invention.

FIG. 4 is a flow diagram of a method 400 for automatically translating information, in accordance with a version of the invention.

FIG. 5 is a block diagram of a system 500 for dynamically customizable platform for ecommerce, in accordance with a version of the invention.

FIG. 6 is a flow diagram of a method 600 for dynamically customizable platform for ecommerce, in accordance with a version of the invention.

FIG. 7 is a block diagram of an electronic, automated educational system 700, in accordance with a version of the invention.

FIG. 8 is a flow diagram of an electronic, automated educational method 800, in accordance with a version of the invention.

FIG. 9 is a block diagram of an electronic, automated information publishing system 900, in accordance with a version of the invention.

FIG. 10 is a flow diagram of an electronic, automated information publishing method 1000, in accordance with a version of the invention.

FIG. 11 is a block diagram of an electronic, automated shopping system 1100, in accordance with a version of the invention.

FIG. 12 is a flow diagram of an electronic, automated shopping method 1200, in accordance with a version of the invention.

FIG. 13 is a block diagram of a system 1300 for global band control, in accordance with a version of the invention.

FIG. 14 is a flow diagram of a method 1400 for global band control, in accordance with a version of the invention.

FIG. 15 is a block diagram of a system 1500 for providing intermediary website content services, in accordance with a version of the invention.

FIG. 16 is a flow diagram of a method 1600 for providing intermediary website content services, in accordance with a version of the invention.

FIG. 17 is a block diagram of a system 1700 for providing reseller website content services, in accordance with a version of the invention.

FIG. 18 is a flow diagram of a method 1800 for providing reseller website content services, in accordance with a version of the invention.

FIG. 19 is a flow diagram of an ecommerce method 1900 for an ecommerce, in accordance with a version of the invention.

FIG. 20 is a flow diagram of method 1912 for initiating a delivery auction process, in accordance with a version of the invention.

FIG. 21 is a flow diagram of a sourcing ecommerce method 2000, in accordance with a version of the invention.

FIG. 22 is a flow diagram of a method 2012 f for initiating a delivery auction process, in accordance with a version of the invention.

FIG. 23 is a block diagram of a system 2100 for localizing a website content, in accordance with a version of the invention.

FIG. 24 is a flow diagram of a method 2200 for localizing a website content, in accordance with a version of the invention.

### DETAILED DESCRIPTION

Throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, data source server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts effectively to convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

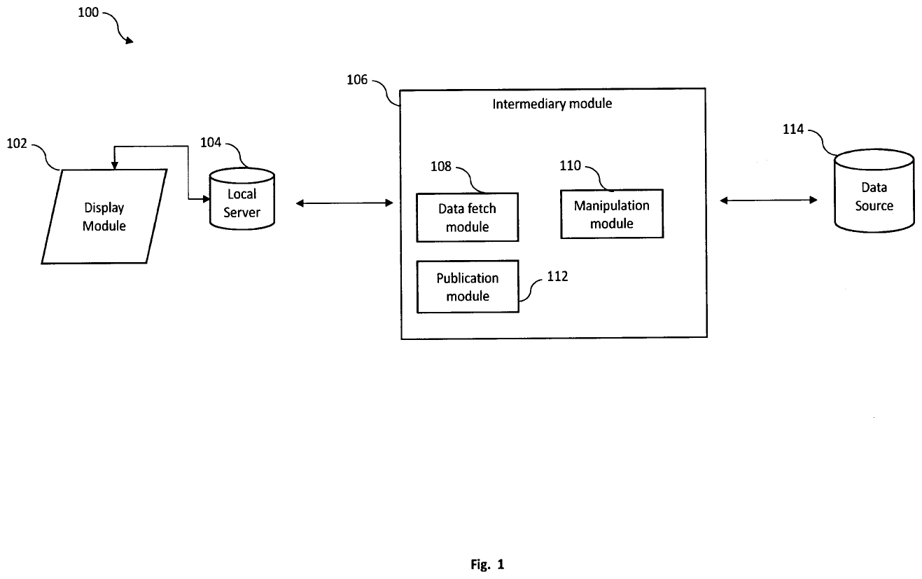

Referring to FIG. 1, a system 100 is shown for automatically, acquiring and publishing data, in accordance with a version of the invention. System 100 includes an input/output module 102, a local server 104 an intermediary server 106, and a data source 114. The intermediary server 104 may further include a data fetch module 108, a manipulation module 110, and a publication module 112.

Input/output module 102 may be a browser like Windows Internet explorer, Google Chrome, Safari, Firefox Mozilla, etc. or a software application executable in a user device like smartphone. The names provided are copyright of respective companies and have been utilized for illustration purposes. In another embodiment, input/output module 102 may be a search engine like Google.com, Bing, Baidu, etc.

Local server 104, may be a general server to host the browser session initiated by a user. In an embodiment of the invention, local server 104 may be configured to host input/output module 102 for a specific geography or a country.

Intermediary server 106 may also be a general server configured for use by a user of another country. Intermediary server 106 may be connected to data source 114.

Further, the modules can be implemented in hardware, instructions executed by a processing unit, or by a combination thereof.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

Input/output module 102 is configured to receive a user query for fetching information. Information may be stored in data source catering another geographical area or country. Input/output module 102 is hosted by local server 104 that is communicably connected to intermediary server 106. Intermediary server 106 receives user's query and fetches and provides information in a format suitable to the user and the country using its multiple modules as described above.

Information to be fetched may be a product's information available in the other country. The request may be received by data fetch module 108 of intermediary server 106. Data fetch module 108 accesses data source 114 for the information. After relevant information is fetched, the information is forwarded to manipulation module 110 that manipulates the same to suit the needs of the user. Manipulation of information may mean translating information format to another format that is from one language to another language or changing layout of data by adding, deleting or modifying information within the date. The information translated may be product's name, information, price for that country by using exchange rate, reviews, and even. Information translation may also be specific shipping information like time of delivery etc. that will be taken. Information added may be shipping information, servicing address, return addresses etc. Such translated information may then be published by publication module 112 on input/output module 102 via local server 104. Publication module may help in maintaining layout of information fetched from data source 114 when displayed on input/output module 102 after manipulation. The translated information may be hosted on an address for example a URL, different from URL of the information hosted on data source 114.

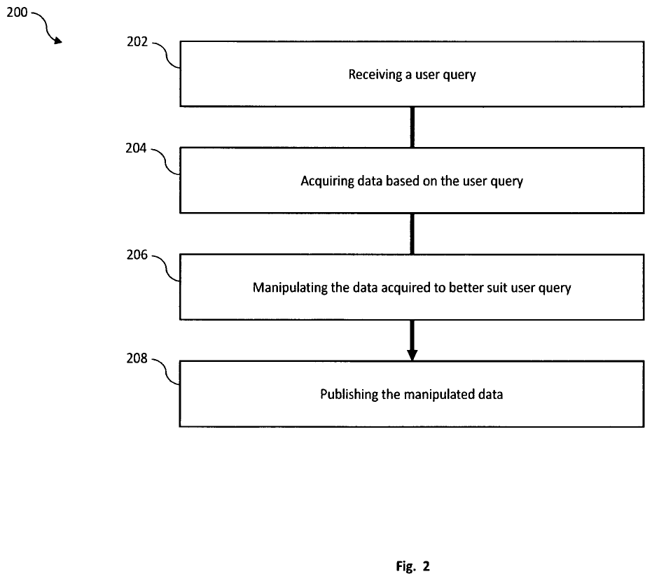

Referring to FIG. 2 a flow chart is shown depicting a method 200 for automatically acquiring, manipulating and publishing data, in accordance with a version of the invention. Reference will be made to FIG. 1 for ease of understanding. The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

At step 202, a user query may be received for information to be fetched from data source 114. User may generate the query through the use of a user device like a smartphone, a laptop, a tablet computer, a personal computer etc. The user request may be entered in input/output module 102 as described earlier may be a browser or a search engine or a software application. The input/output module is hosted on the local server that caters to the specific country.

At step 204, information to be accessed is acquired based on the user's query. Further at step 206, accessed information is manipulated in order to suit the information best for the user. The manipulation, as described earlier, may mean translating information for the user in the local format. The translation may be done in real time.

At step 208, the manipulated data is then published on input/output module for the user. Manipulated data may be hosted on an address like a URL. The publication module 112, hosts the manipulated data on a URL that is different from original URL when information is hosted on data source 114.

In an exemplary usage, a user from Country A wants to access a Brandx.com website content for a product A. The user will go to input/output module 102 to enter a search query. The search query, received by the local server 104 is analyzed and determined that it is for a product not available Country A. The query is then sent to intermediary server 106 wherein the data fetch module 108 receives the query and identifies data source 114 which hosts Brandx.com. Further, the website content is fetched and forwarded to manipulation module 110. Manipulation module 110 identifies that Brandx.com is not suitable for the user due to language and other information like currency for costs etc. Manipulation module 110 further manipulates or translates the information of Brandx.com and sends it to publication module 112. Publication module, alter the URL to may be shop4e/brandx.com and publishes to information on input/output module 102 for the user. In this manner user receives information in his own language and in format suitable to the user.

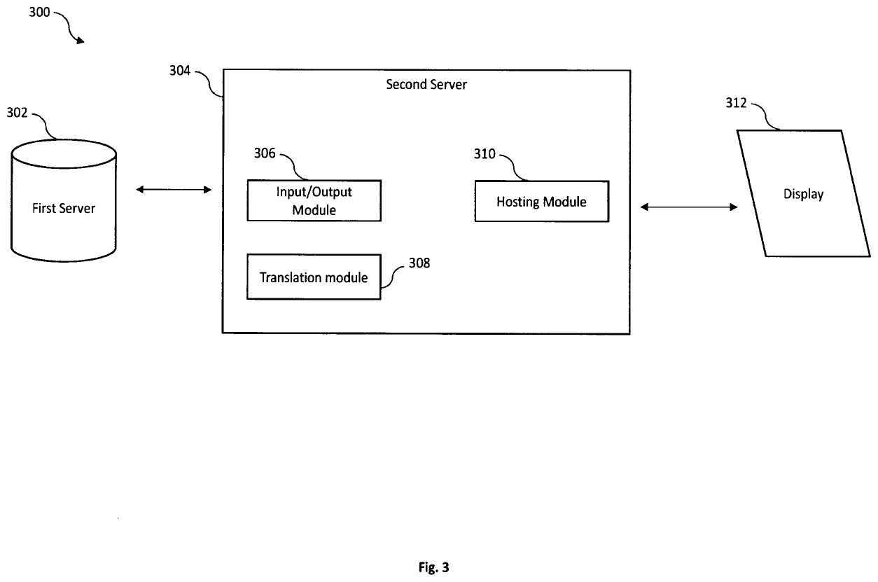

Referring to FIG. 3, a system 300 is shown for automatically translating information, in accordance with a version of the invention. System 300 includes a first server 302, a second server 304, and an input/output module 306. Second server 304 may further include multiple modules that may be hardware modules or software modules invoked using stored instructions. Second server 304 includes an input/output module 306, a hosting module 308 and a translation module 310.

First server 302 may be configured to store information in a first format. Information may be the ecommerce website content stored in a first language. First server 302 may be communicably connected to second server 304 through the network. Second server 304 may be communicably connected to a user device (not shown in the figure). Display 312, may be provided within the user device. Display 312 may be pushed by input/output module 306. Display 312 may be configured to receive a user's input. Input may be received from any input device like keyboard, mouse, touch screen etc.

The user, from a country different from country of placement of first server 302, may enter a search query for the information stored on the first server. The search query may be received by translation module 308 that may fetch the information from first server 302. Further to fetching the information, translation module 308 may further translate the information fetched into a language best suitable to the user's country. Furthermore, translation module 308 maintains the layout of the information fetched from first server 302 while translating. The translated information is then transmitted to the hosting module 310 to be forwarded to input/output module 306 that pushes the translated information to the display 312.

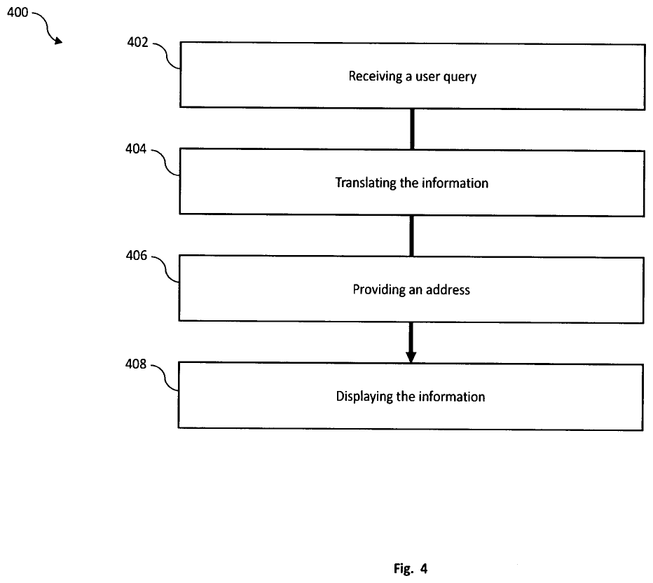

Referring to FIG. 4, a flow diagram is shown of a method 400 for automatically translating information, in accordance with a version of the invention. Reference will be made to FIG. 3 for ease of understanding. At step 402, a user query is received for a user query may be received for information to be fetched from first server 302. The user request may be entered in display 312 as described earlier may be a browser or a search engine or a software application.

At step 404, accessed information is translated in order to suit the information best for the user. The translation may be done in real time. At step 406, the translated information is provided with an address to be displayed on display 312. The address, according to an embodiment may be a URL. The translated may be hosted on the URL that is different from original URL when information is hosted on first server 302.

At step 408, the translated data is then displayed on display 312 for the user.

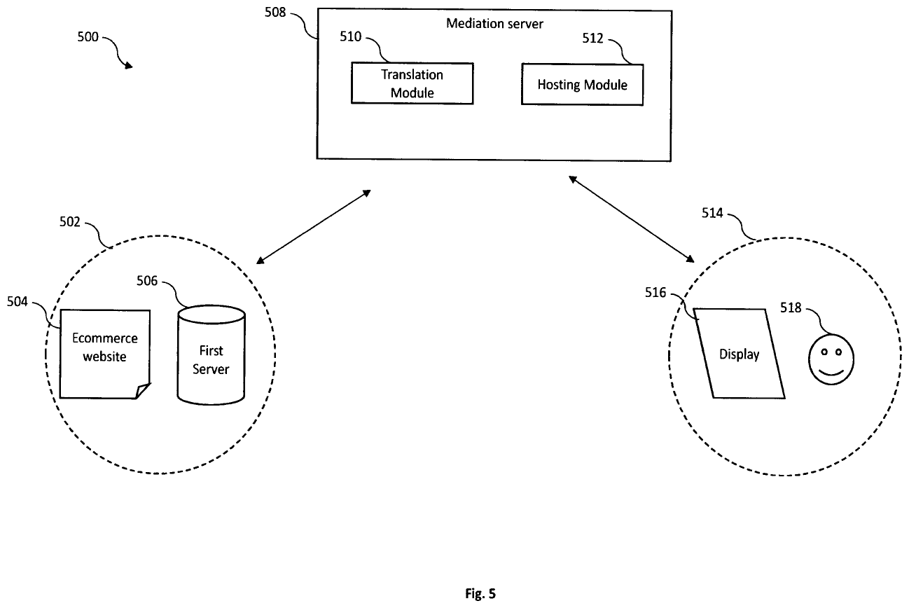

Referring to FIG. 5, a block diagram is shown of a system 500 for dynamically customizable platform for ecommerce, in accordance with a version of the invention. System 500 includes an ecommerce website content 504 hosted on a first server 506 within a first country 502. System 500 further includes a mediation server 508, and a display 516 on a user device (not shown in the figure) in a second country 514. The mediation server 508 may further include multiple modules. These multiple modules may be a translation module 510, and a hosting module 512.

The ecommerce website content 502 may include products offered for sale. As described earlier, ecommerce website content 502 is hosted by a first server. A user may logon to the ecommerce website content may look and order various products. However, ecommerce website content 502 may be hosted by first server 504 for a particular country only, like country 502. Any user outside country 502, may not be able to access the products or other information.

According to an embodiment of the invention, first server 506 may be communicably connected to mediation server 508 which in turn is connected to display 516 placed in country 514. Mediation server may be in either be placed in country 502, country 514 or any other country.

In operation, user 518 in country 514, looking to access ecommerce website content 504 may enter a search query on display 516. Display 516 may be hosted by hosting module 512. The search query may be received by translation module 510 that fetches the information from ecommerce website content 502, based on the search query. Information may be complete ecommerce website content 502. Translation module 510 may further translate the ecommerce website content and modify other properties like costs in currency of country 514, shipping information to suit country 514 etc. the translated ecommerce website content is then forwarded to hosting module 512 to be provided with a URL different from URL of ecommerce website content 504. After providing suitable URL, translated ecommerce website content is displayed on display 516 for user 518.

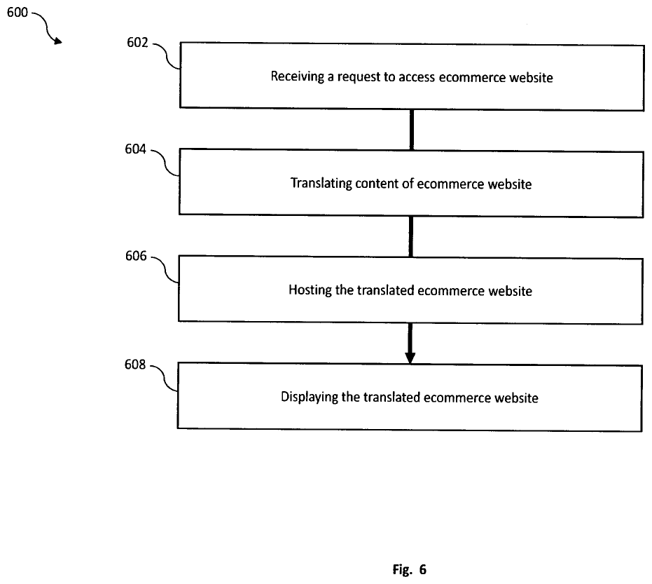

FIG. 6 illustrates a flow diagram of a method 600 for a dynamically customizable platform for ecommerce, in accordance with a version of the invention. Reference will be made to FIG. 5 for ease of understanding. At step 602, a user query for accessing an ecommerce website content of another country is received. At step 604, the ecommerce website content is fetched, and content of the ecommerce website content is translated into a language suitable for the country.

Further at step 606, the translated copy of the ecommerce website content is hosted by providing a URL different from URL of the ecommerce website content. The translated ecommerce website content is displayed on the URL provided on a display for the user, at step 608.

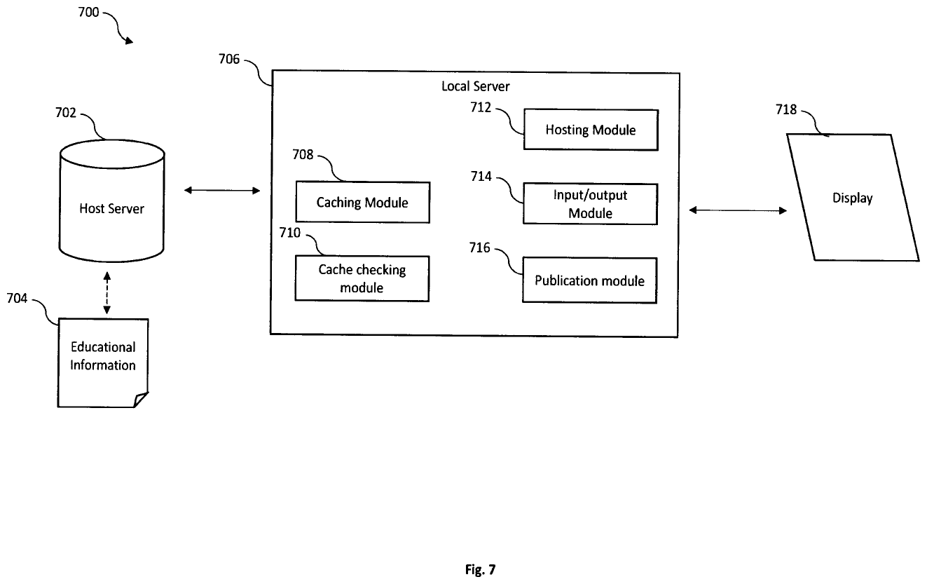

Referring to FIG. 7, a block diagram illustrates an electronic, automated educational system 700, in accordance with a version of the invention. System 700 includes a host server 702 that hosts an educational information 704. System 700 further includes a local server 706, and a display 718.

Further, the local server 706 may further include multiple modules like a caching module 708, cache checking module 710, hosting module 712, an input/output module 714, and a publication module 716.

As described above, the modules can be implemented in hardware, instructions executed by a processing unit, or by a combination thereof.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

Host server 702 is communicably connected to local server 706 through the network. Further, local server 706 may be further communicably connected to display 718.

Caching module 708 of local server 706 may be communicably connected to host server 702 in order. On other side caching module 708 is connected to a cache checking module 710. Cache checking module 708 may also be connected to host server 702. Further, caching module 708 may also be communicably connected to publication module 716. Publication module 716 may further be communicably connected to hosting module 712 which in turn is connected to input/output module 714.

A user, stationed in a foreign country, may want to access educational information 704, hosted by host server 702 in a local country through the user device as described above in the description. The educational information may not be accessible in the foreign country. The user may access educational information by entering a user query on an input screen presented to the user on display 718 of the user device. The user query is received by input/output module 714 that forwards the request to cache checking module 710. Cache checking module 710 checks whether caching module 708 contains latest copy of educational information 704 or not.

In case the copy is not the latest copy, caching module 708 fetches latest copy of educational information 704 from host server 702. However, in case caching module 708 contains latest copy of the educational information 704, the caching module 708, forwards the copy of educational information 704 to the publication module 716.

Publication module 716, further translates the copy of the educational information 704 suitable as per foreign country where user is stationed. The translated copy of the educational information may then be forwarded to hosting module 712 that provides an address that may be a URL for hosting. The URL may be different from URL of educational information 704 on host server 702. URL for the translated educational information may include some indication of the URL for educational information 704 on host server 702. The translated educational information may then be displayed by displaying module 714, after receiving the URL information from hosting module 712. The translated copy of educational information may be displayed on display 718.

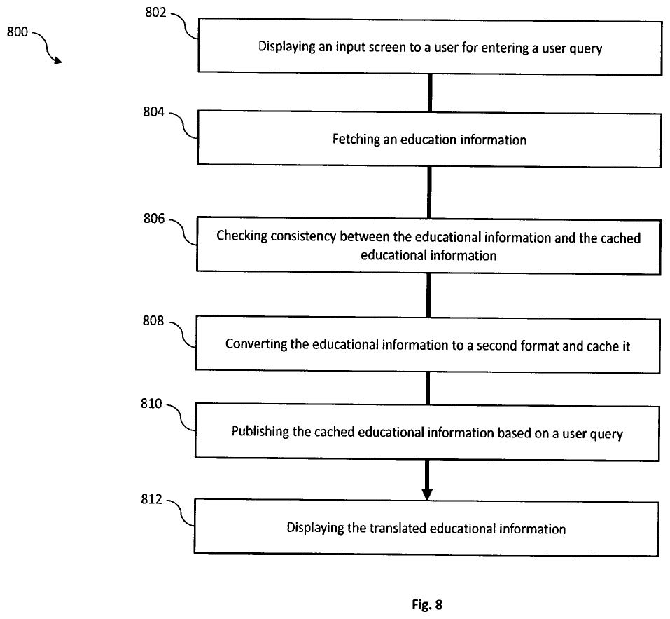

Referring to FIG. 8, a flow diagram illustrates an automatic education method 800, in accordance with a version of the invention. Reference will be made to FIG. 7 for ease of understanding. At step 802, an input screen is provided to the user, on the user device for entering search query for accessing educational information 704. As described in description in conjunction with FIG. 7, educational information 704 may not be able to the user stationed in a foreign country. The input screen may be a browser window or a search engine.

At step 804, educational information 704 is fetched, from caching module 708, based on user's search query. Educational information 704 may be stored in a first format like a first language on host server 702. At step 806, cache checking module 710 checks consistency of between educational information 704 and the cached educational information stored in caching module 708. In case, caching module 708 contains copy of educational information 704 consistent with all updated information of educational information 704. In case the cached copy of educational information 704 is not consistent with updated educational information 704, then a latest copy of the education al information 704 is fetched by caching module 708.

At step 808, educational information 704 is fetched, translated into a second format and cached. The second format may include a second language. At step 810, the translated copy of the educational information 704 is published by adding a URL for hosting. The URL may be different from URL of educational information 704 on host server 702. URL for the translated educational information may include some indication of the URL for educational information 704 on host server 702. Further, at step 810, the translated educational information 704 is displayed to the user on display 718 on the URL added.

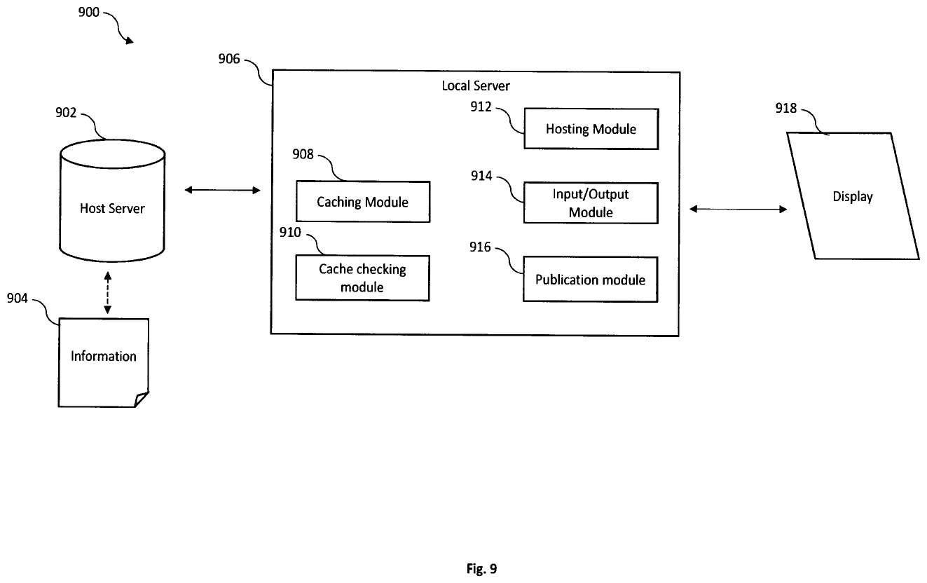

Referring to FIG. 9, a block diagram illustrates an electronic, automated information publishing system 900, in accordance with a version of the invention. System 900 includes a host server 902 that hosts an information 904. System 900 further includes a local server 906, and a display 918.

Further, the local server 906 may further include multiple modules like a caching module 908, cache checking module 910, hosting module 912, an input/output module 914, and a publication module 916.

As described above, the modules can be implemented in hardware, instructions executed by a processing unit, or by a combination thereof.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

Host server 902 is communicably connected to local server 906 through the network. Further, local server 906 may be further communicably connected to display 918.

Caching module 908, of local server 906 may be communicably connected to host server 902 in order. On other side, caching module 908 is connected to a cache checking module 910. Cache checking module 908 may also be connected to host server 902. Further, caching module 908 may also be communicably connected to publication module 916. Publication module 916 may further be communicably connected to hosting module 912 which in turn is connected to input/output module 914.

A user, stationed in a foreign country, may want to access information 904, hosted by host server 902 in a local country through the user device as described above in the description. The educational information may not be accessible in the foreign country. The user may access educational information by entering a user query on an input screen presented to the user on display 918 of the user device. The user query is received by input/output module 914 that forwards the request to cache checking module 910.

Cache checking module 910 checks whether caching module 908 contains latest copy of information 904 or not. In case the copy is not the latest copy, caching module 908 fetches latest copy of information 904 from host server 902. However, in case caching module 908 contains latest copy of the information 904, the caching module 908, forwards the copy of information 904 to the publication module 916.

Publication module 916, further translates the copy of the information 904 suitable as per foreign country where user is stationed. The translated copy of the information may then be forwarded to hosting module 912 that provides an address that may be a URL for hosting. The URL may be different from URL of information 904 on host server 902. The URL for the translated information may include some indication of the URL for information 904 on host server 902. The translated information may then be displayed by displaying module 914, after receiving the URL information from hosting module 912. The translated copy of information 904 may be displayed on display 918.

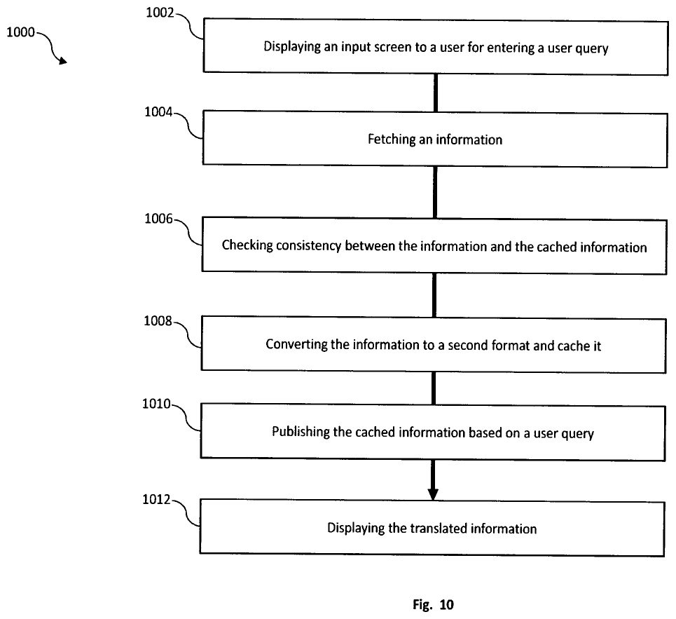

Referring to FIG. 10, a flow diagram illustrates an automated information publishing method 1000, in accordance with a version of the invention. Reference will be made to FIG. 9 for ease of understanding. At step 1002, an input screen is provided to the user on the user device for entering search query for accessing information 904. As described in description in conjunction with FIG. 9, information 904 may not be accessible to the user stationed in a foreign country. The input screen may be a browser window or a search engine.

At step 1004, information 904 is fetched from caching module 908, based on user's search query. Information 904 may be stored in a first format like a first language on host server 902. At step 1006, cache checking module 910 checks consistency of between information 904 and the cached information stored in caching module 908. In case, caching module 908 contains copy of information 904 consistent with all updated information of information 904. In case the cached copy of information 904 is not consistent with updated information 904, then a latest copy of the information 904 is fetched by caching module 908.

At step 1008, information 904 is fetched, translated into a second format. The second format may include second language. At step 1010, translated copy of information 904 is published by adding a URL for hosting. The URL may be different from the URL of information 904 on host server 902. The URL for the translated information may include some indication of the URL for information 904 on host server 902. Further at step 1010, the translated information 904 is displayed to the user on display 918 on the URL added.

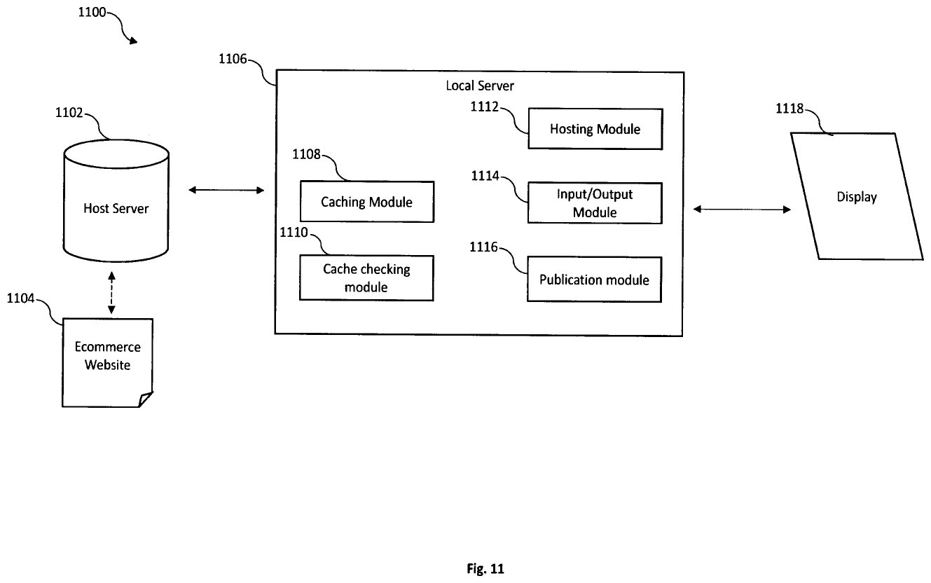

Referring to FIG. 11, a block diagram illustrates an electronic, automated shopping system 1120, in accordance with a version of the invention. System 1120 includes a host server 1102 that hosts an ecommerce website content 1104. System 1120 further includes a local server 1106, and a display 1118.

Further, the local server 1106 may further include multiple modules like a caching module 1108, cache checking module 1112, hosting module 1112, an input/output module 1114, and a publication module 1116.

As described above, the modules can be implemented in hardware, instructions executed by a processing unit, or by a combination thereof.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

Host server 1102 is communicably connected to local server 1106 through the network. Further, local server 1106 may be further communicably connected to display 1118.

Caching module 1108 of local server 1106 may be communicably connected to host server 1102 in order. On other side, caching module 1108 is connected to a cache checking module 1112. Cache checking module 1108 may also be connected to host server 1102. Further, caching module 1108 may also be communicably connected to publication module 1116. Publication module 1116 may further be communicably connected to hosting module 1112, which in turn is connected to input/output module 1114.

A user, stationed in a foreign country, may want to access ecommerce website content 1104, hosted by host server 1102 in a local country through the user device as described above in the description. The educational information may not be accessible in the foreign country. The user may access educational information by entering a user query on an input screen presented to the user on display 1118 of the user device. The user query is received by input/output module 1114 that forwards the request to cache checking module 1112.

Cache checking module 1112 checks whether caching module 1108 contains the latest copy of ecommerce website content 1104 or not. In case the copy is not the latest copy, caching module 1108 fetches latest copy of ecommerce website content 1104 from host server 1102. However, in case caching module 1108 contains latest copy of the ecommerce website content 1104, the caching module 1108, forwards the copy of ecommerce website content 1104 to the publication module 1116.

Publication module 1116, further translates the copy of the ecommerce website content 1104 to be suitable for use in the foreign country where the user is stationed. The translated copy of the information may then be forwarded to hosting module 1112 that provides an address that may be a URL for hosting. The URL may be different from URL of ecommerce website content 1104 on host server 1102. URL for the translated information may include some indication of the URL for ecommerce website content 1104 on host server 1102. The translated information may then be displayed by displaying module 1114, after receiving the URL information from hosting module 1112. The translated copy of information may be displayed on display 1118.

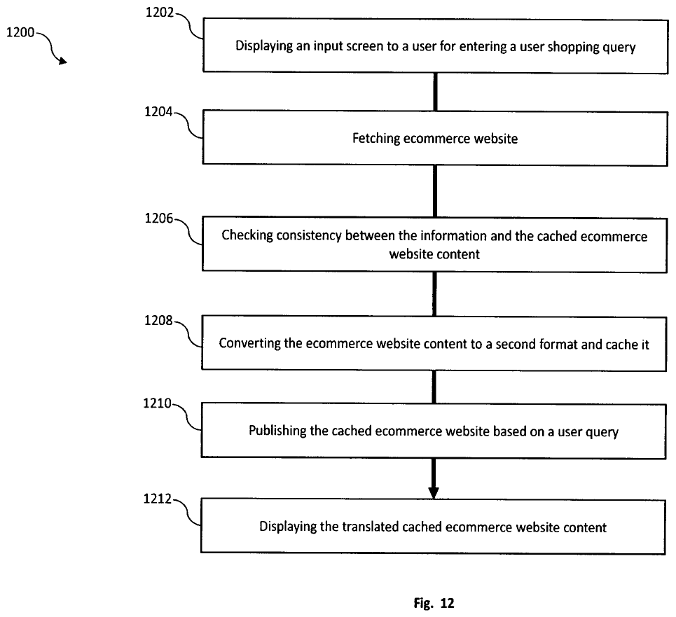

Referring to FIG. 12, a flow diagram illustrates an automated information publishing method 1200, in accordance with a version of the invention. Reference will be made to FIG. 11 for ease of understanding. At step 1202, an input screen is provided to the user, on the user device for entering search query for accessing ecommerce website content 1104. As described in description in conjunction with FIG. 11, ecommerce website content 1104 may not be accessible to the user stationed in a foreign country. The input screen may be a browser window or a search engine.

At step 1204, ecommerce website content 1104 is fetched from caching module 1108, based on user's search query. Ecommerce website content 1104 may be stored in a first format like a first language on host server 1102. At step 1206, cache checking module 1112 checks consistency of between ecommerce website content 1104 and the cached information stored in caching module 1108. In one case, caching module 1108 contains a copy of ecommerce website content 1104 consistent with all updated information of ecommerce website content 1104. In another case, the cached copy of ecommerce website content 1104 is not consistent with updated ecommerce website content 1104, and then a latest copy of the ecommerce website content 1104 is fetched by caching module 1108.

At step 1208, ecommerce website content 1104 is fetched, and translated into a second format. Second format may include second language. At step 1212, a translated copy of ecommerce website content 1104 is published by adding a URL for hosting. The URL may be different from URL of ecommerce website content 1104 on host server 1102. URL for the translated information may include some indication of the URL for ecommerce website content 1104 on host server 1102. Further at step 1212, the translated ecommerce website content 1104 is displayed to the user on display 1118 on the URL added.

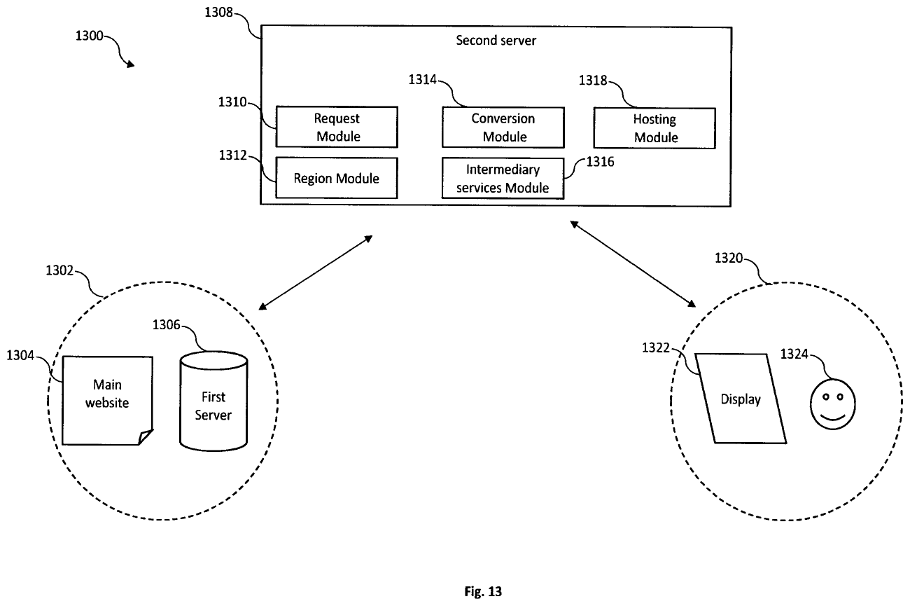

Referring to FIG. 13, a block diagram illustrates a system 1300 for global brand control, in accordance with a version of the invention. System 1300 includes a main website content 1304 hosted on a first server 1306 within a first country 1302. System 1300 further includes a second server 1308, and a display 1322 on a user device (not shown in the figure) in a second country 1320.

The second server 1308 may further include multiple modules. These multiple modules may be a request module 1310, region module 1312, conversion module 1314, an intermediary services module 1316, and a hosting module 1318.

The main website content 1304 may either include information or include products offered for sale. As described earlier, main website content 1304 is hosted by a first server 1306. A user may logon to main website content 1304 and may look and order various products. However, main website content 1304 may be hosted by first server 1306 for a particular country only like country 1302. Any user outside, country 1302 may not be able to access the products or other information from main website content 1304.

In operation user 1324 in country 1320, looking to main website content 1304 may enter a search query on display 1322. Display 1322 may be hosted by hosting module 1318. The search query may be received by request module 1310. The search query may also be received by region module 1312 to determine region or country of user 1324 generating the request. This may be done by identifying router, switch or network information from information header of the request.

Request module 1310 fetches main website content 1304, based on the search query of user 1324. Conversion module 1314 may further receive main website content 1304, and region information of user 1324 from region module 1312. Conversion module 1314 converts main website content 1304 like converting language information of main website content 1304. Intermediary services module 1316 further adds intermediary services to converted main website content 1304. Intermediary services may be anyone, or a combination of shipment carriers, payment service providers, translation service providers, local sales channel providers, local social networks, or marketing service providers. The translated main website content along with intermediary services information is then forwarded to hosting module 1318 to be provided with a URL different from URL of main website content 1304. After providing a suitable URL, the translated main website content is then displayed on display 1322 for user 1324.

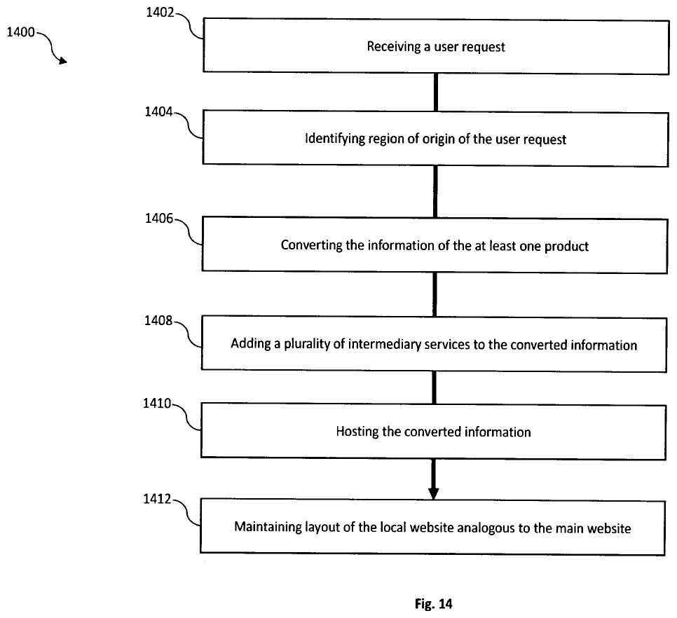

Referring to FIG. 14, a flow diagram illustrates a method 1400 for global band control, in accordance with a version of the invention. Reference will be made to FIG. 13 for ease of understanding. At step 1402, a user 1324, stationed in country 320, requests to access at least one product from main website content 1304 or complete main website content 1304, only available in country 1302. At step 1404, the region of the origin of the request is identified, which may be done by identifying the network.

Further, at step 1406, the at least one product information or complete main website content 1304 may be translated based on the region identified. At step 1408, a plurality of intermediary services may be added to the translated main website content 1304. Intermediary services may be provided to better suit the first country. For example, intermediary services may be shipment information, indigenous shipment carriers, costs in local currency, etc. At step 1410, the translated information along with intermediary services information is hosted on a URL that is different from URL of main website content 1304 when hosted on first server 1306 in country 1302.

Further, at step 1412, the layout of the translated main website content or local website content is maintained to be substantially analogous with layout of main website content 1304.

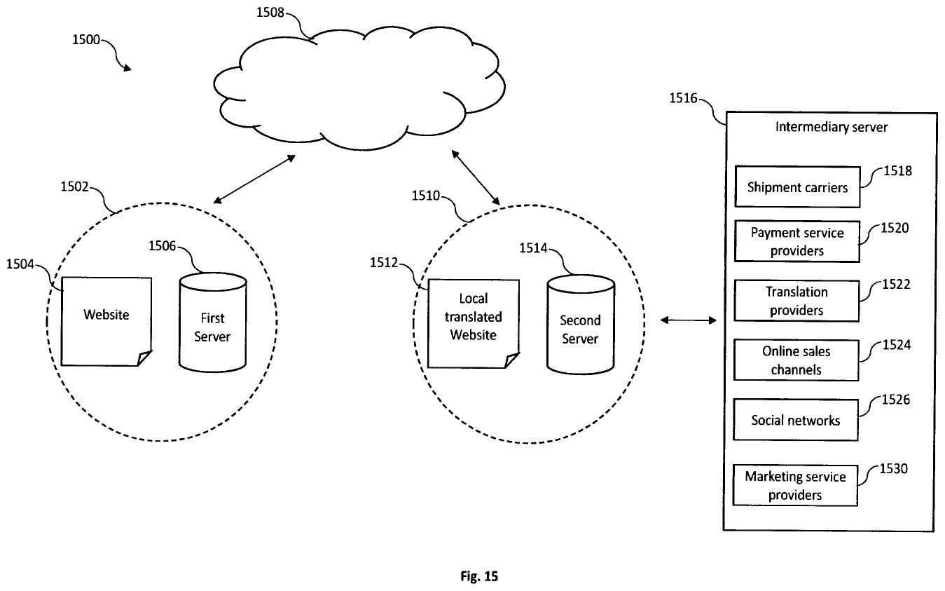

Referring to FIG. 15, a block diagram illustrates a system 1500 for providing intermediary website content services, in accordance with a version of the invention. System 1500 includes a website content 1504 hosted on a first server 1506 within a first country 1502. System 1500 further includes a second server 1514 in second country 1520, and a network 1508.

System 1500 may further include an intermediary server 1516 which may include multiple modules. These multiple modules may be a shipment carriers module 1518, payment services module 1520, translation module 1522, online sales module 1524, social networks 1526, and a marketing services module 1528.

Network 1508 may be a wired or wireless network. The wired network may be a wired Local Area Network, wired Wide Area Network, or a wired Metropolitan Area Network. The wireless network may include Wi-Fi, wireless LAN, MAN or WAN, or mobile networks like 2G, 3G, and 4G, etc.

The main website content 1504 may either include information or include products offered for sale. As described earlier, main website content 1504 is hosted by a first server 1506. A user may logon to main website content 1504 and may look and order various products. However, main website content 1504 may be hosted by first server 1506 for a particular country only like country 1502. Any user outside, country 1502 may not be able to access the products or other information from main website content 1504.

First server 1506 may be communicably connected to second server 1514 through network 1508. Second server 1514 may be further connected to intermediary server 1516. Intermediary server 1516 connects various types of service providers connecting to each module of multiple modules as described above. For example, various shipping carriers may be connected to second server 1514 through shipping carriers' module 1518.

In operation user 1514 in country 1510, looking to access website content 1504 may enter a search query on display of the user device. The search query may be transmitted to first server 1506 through network 1508. Based on the search query of user 1514, website content 1504 is accessed by second server 1514. Further, intermediary server 1516 provides various service providers to add information to better suit country 1510. For example, language of information on website content 1504 is translated to local language of country 1510 by translation service providers providing their service through translation module 1522. Further shipping information may be updated on website content 1504, through information fetched from shipment carriers through shipment carrier module 1518.

Intermediary services may be any one or a combination of shipment carriers, payment service providers, translation service providers, local sales channel providers, local social networks, or marketing service providers. The converted main website content along with intermediary services information that is local translated website content 1512, hosted by second server 1514, is then forwarded to user with a URL different from URL of website content 1504. After providing a suitable URL, the converted main website content is then displayed on display for user of country 1510.

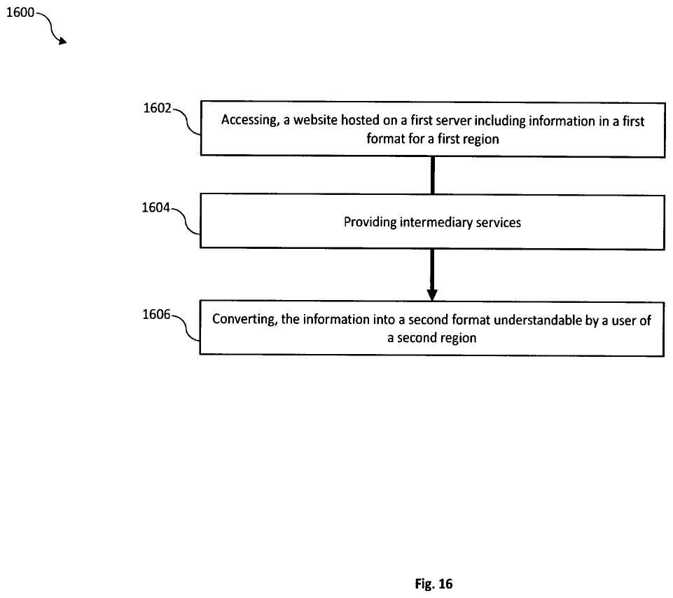

Referring to FIG. 16, a flow diagram illustrates a method 1600, for providing intermediary website content services, in accordance with a version of the invention. Reference will be made to FIG. 15 for ease of understanding. At step 1602, a user request for accessing website content 1504, hosted on first server 1506 in a first format (language, etc.) for a region is received. The user request may be generated or routed through second server 1514 in second country 1510 connected to first server 1506 through network 1508. At step 1606, intermediary services are added as have been described above to fetched website content 1504. After the website content 1504, has been completely converted to local translated website content 1512, to suit the user of second country 1510, at step 1608, it is then provided to the user in second format suitable for country 1510.

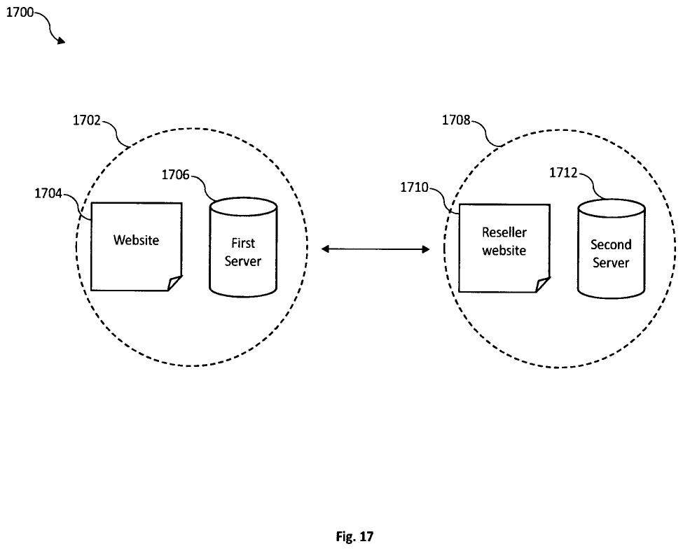

Referring to FIG. 17, a block diagram illustrates a system 1700 for providing reseller website content services in accordance with a version of the invention. System 1700 includes a website content 1704 hosted on a first server 1706 within a first country 1702. System 1700 further includes a second server 1712 in a second country 1708.

The main website content 1704 may either include information or include products offered for sale. As described earlier, main website content 1704 is hosted by first server 1706. A user may logon to main website content 1704 may look and order various products. However, main website content 1704 may be hosted by first server 1706 for a particular country only like country 1702. Any user outside, country 1702 may not be able to access the products or other information from main website content 1704.

First server 1706 may be communicably connected to second server 1514 through a network. Second server 1712 may add various types of reseller services like shipment information, indigenous shipment carriers, costs in local currency, etc. useful and best suited for country 1708.

In operation, the user in country 1708, looking to access website content 1704 may enter a search query on display of the user device. The search query may be transmitted to first server 1706. Based on the search query of the user, website content 1704 is accessed by second server 1712. Further, second server 1712 adds various reseller services information to better suit country 1708. For example, language of information on website content 1704 is translated to local language of country 1708 by translation service providers providing their service through second server 1712. Further shipping information may be updated on website content 1704, through information fetched from shipment carriers through second server 1712. The main website content converted to reseller website content along with reseller services information, is hosted by second server 1712, is then forwarded to the user at a URL different from URL of website content 1704. After providing suitable URL, converted main website content is then displayed on display for user of country 1708.

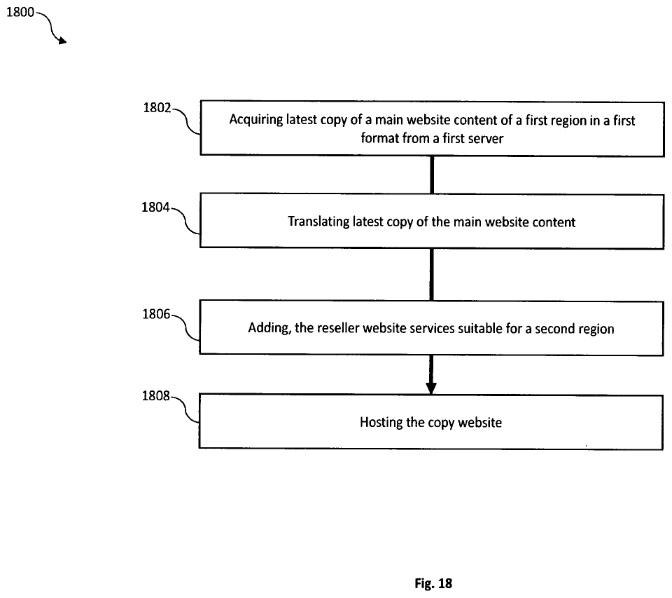

Referring to FIG. 18, a flow diagram illustrates a method 1800 for providing reseller website content services, in accordance with a version of the invention. Reference will be made to FIG. 17 for ease of understanding. At step 1802, a request for acquiring latest copy of main website content 1704, hosted on first server 1706 in first format for first country 1702, is received by second server 1712.

At step 1804, the latest copy of main website content 1704 is translated to second format 1804. In this embodiment of the invention, first format and second format mean first language and second language for first country 1702 and second country 1708 respectively.

At step 1806, second server 1712 adds reseller website content services, as described above, to the translated copy of main website content 1704 to form reseller website content 1710. At step 1808, reseller website content 1710 is hosted by second server 1712 after being provided with a URL different from URL of main website content 1704.

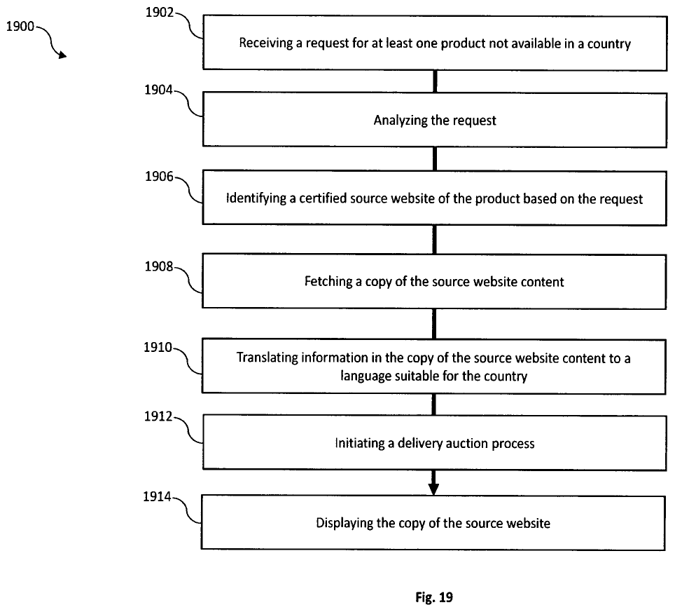

Referring to FIG. 19, a flow diagram illustrates an ecommerce method 1900, in accordance with a version of the invention. The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

At step 1902, a request from a first country, for at least one product not available in the first country, is received. The request may be generated from an input screen provided on a user device. At step 1904, the request received is analyzed. Further at step 1906, a certified source of website content is identified from the request analyzed. The identification is made for identifying certified source of the at least one product and country where it is available.

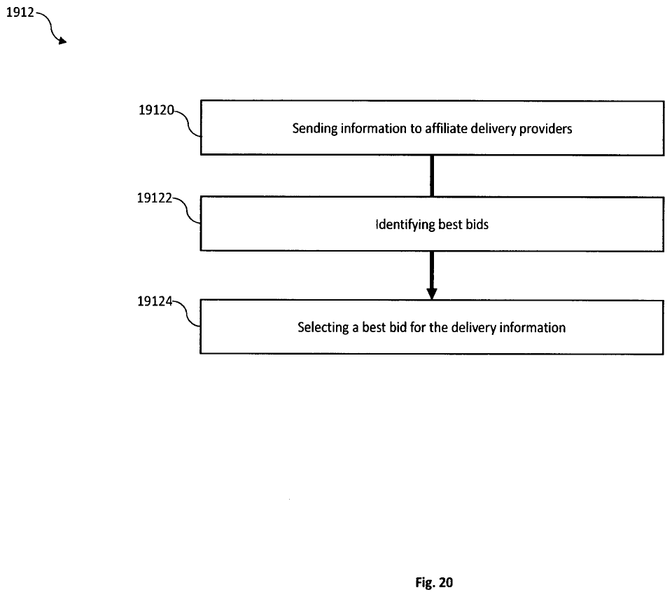

At step 1908, copy of the certified source website content is fetched based on the user's request. At step 1910, information within the copy of the certified source website content is translated to a language suitably for the country of the user. At step 1912, a delivery auction process is initiated to determine delivery details suitable for the country of the user. Details of the step 1912 will be explained later, in conjunction with description of FIG. 20.

After receiving suitable delivery details, at step 1914, the copy of the source website content is displayed to the user on the user device.

Referring to FIG. 20, a flow diagram illustrates details of step 1912 for initiating the delivery auction, in accordance with a version of the invention. At step 19120, information to affiliate delivery providers is sent to all the delivery providers willing to provide delivery in the country of the user, wherein the information sent is about a confirmed buying request from the user. After receiving information, the affiliate delivery providers bid for providing the delivery. At step 19122, best bid from the bids received is identified. The bids receive information about time for delivery, costing, time to respond to the auction process, and previous customer reviews. Further at step 19124, best bid from all bids received is selected based on parameters described above. The delivery information selected is then added to the translated source website content information.

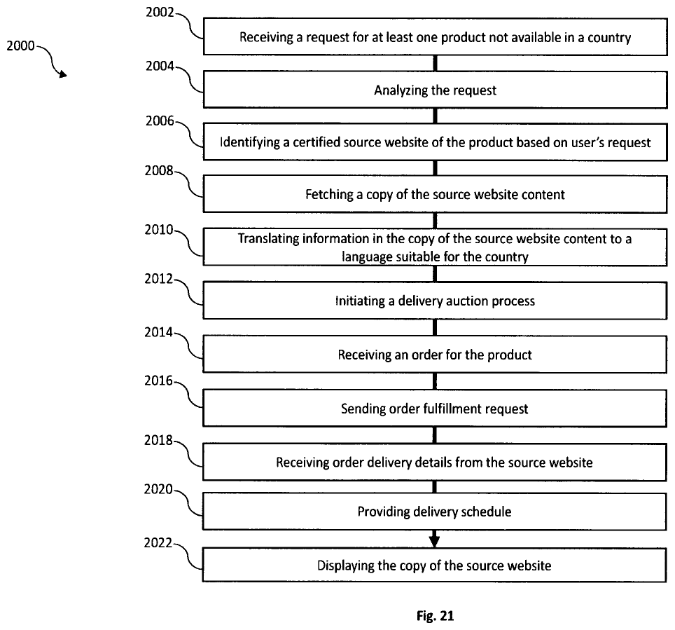

Referring to FIG. 21, a flow diagram illustrates a sourcing ecommerce method 2000, in accordance with a version of the invention. At step 2002, a request from a first country, for at least one product not available in the first country, is received. The request may be generated from an input screen provided on a user device. At step 2004, the request received is analyzed. Further at step 2006, a certified source of website content is identified from the request analyzed. The identification is made for identifying certified source of the at least one product and country where it is available.

At step 2008, a copy of the certified source website content is fetched based on the user's request. At step 2010, information within the copy of the certified source website content is translated to a language suitably for the country of the user. At step 2012, a delivery auction process is initiated to determine delivery details suitable for the country of the user. Details of the step 2012 will be explained later, in conjunction with description of FIG. 20.

After receiving suitable delivery details, at step 2014, an order for the at least one product is received by the user. Further at step 2016, after user confirms buying order, the order of the product is received. At step 2018, an order fulfillment request is sent to the source website content for the at least one product. At step 2020, the delivery schedule based on received bids is provided. Further at step 2022, the copy of the source website content along with delivery schedule of all bids received is provided to the user. The user may choose a delivery schedule option as per his own choice. In another embodiment, the user may be provided only the best delivery schedule received after delivery auction process.

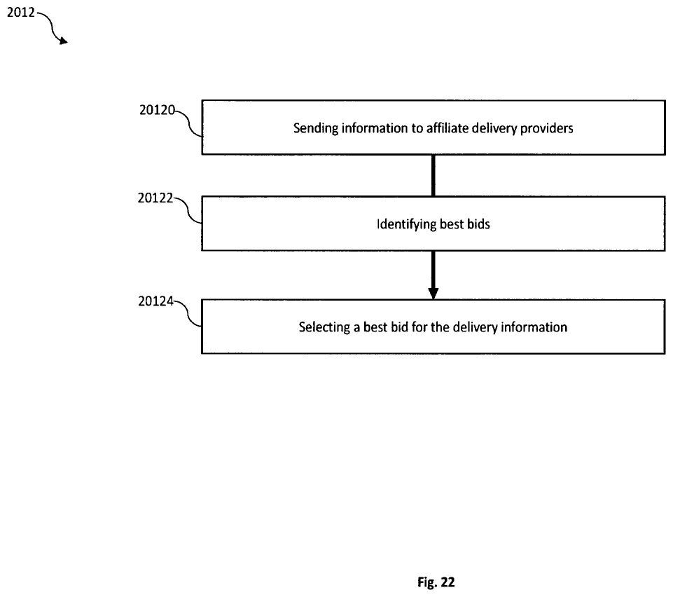

Referring to FIG. 22, a flow diagram illustrates details of step 2012 for initiating the delivery auction, in accordance with a version of the invention. At step 20120, information to affiliate delivery providers is sent to all the delivery providers willing to provide delivery in the country of the user, wherein the information sent is about a buying interest of the at least one product by the user. After receiving information, the affiliate delivery providers bid for providing the delivery. At step 20122, best bid from the bids received is identified. The bids receive information about time for delivery, costing, time to respond to the auction process, and previous customer reviews. Further at step 20124, best bid from all bids received is selected based on parameters described above. The delivery information selected is then added to the translated source website content information.

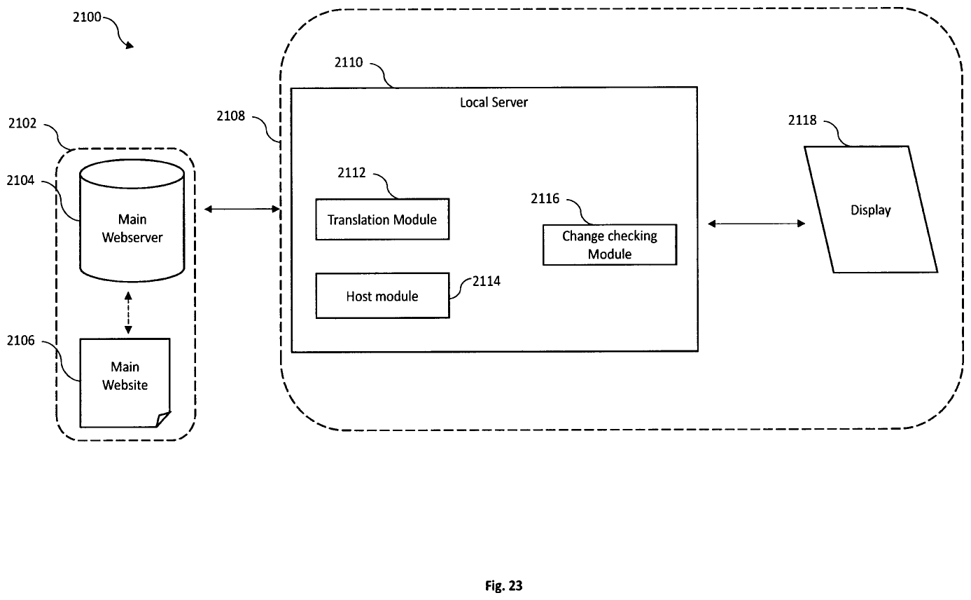

Referring to FIG. 23, a block diagram illustrates a system 2100 for localizing a website content, in accordance with an embodiment of the invention. System 2100 includes a main webserver 2104 a website content 2106, a local server 2110, and a display 2118.

The local server may include multiple modules. Multiple modules may include a translation module 2112, a host module 2114, a memory 2120 and a change checking module 2116.

The modules can be implemented in hardware, instructions executed by a processing unit, or by a combination thereof.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

Main server 2104 may host website content 2106 within a first country 2102. Main server 2104 may be connected to local server 2110 that may be placed in a second country 2108. Display 2118 may also be connected to local server 2110 and may also be placed in second country 2108.

Display 2118 may be an input screen of a user device. Further, the display 2118 may be hosted by host module 2114. Display 2118 may be a browser or a search engine for accessing various information from internet.

Translation module 2112 may be communicably connected to main server 2104. Change checking module 2116 may be connected to translation module 2112 on one side and to host module 2114 on the other side.

In operation, a user stationed in second country 2108 trying to access website content 2106, may enter search query, like address or URL of website content 2106, on display 2118. The search query generated is received by local server through host module 2114. Host module 2114 analyzes search query. Analysis includes whether the site has been requested by the user, or any other user from second country 2108. In case, it was accessed before, then hosting module checks for a cached copy of main website content 2106 in memory 2120. If a cached copy of main website content 2106 is available within memory 2120.

Further, host module 2114 may also instruct change checking module 2116 to check in case content of the cached website content matches current website content 2106 or not. If not, host module 2114, may instruct translation module 2112 to fetch current copy of website content 2106. In addition to fetching current copy, translation module also translates all content of website content 2106 into a language native to second country 2108. Cache content is also updated. This current translated copy website content may be then hosted by host module 2114 on an address or URL different from the address or the URL of website content 2106. The translated copy of website content is then presented to the user on the user device.

However, if cached copy of website content 2106 is consistent with current content of website content, hosting module may instruct translation module 2112 to check translation of cached content. In case, translation of content is good, then host module 2114, hosts the cached copy of website content 2106 on an address or URL different from the address or the URL of website content 2106.

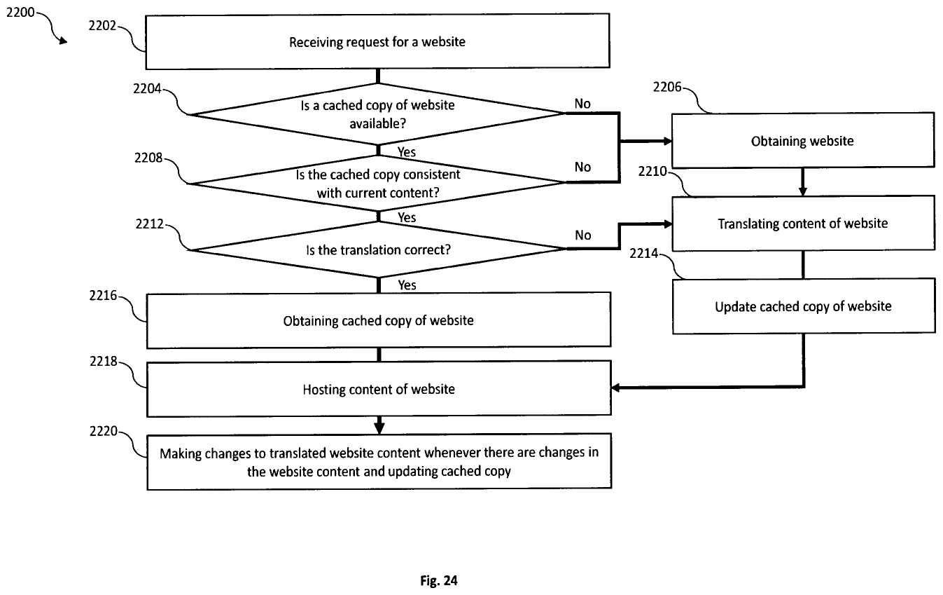

Referring to FIG. 24, a flow diagram illustrates a method 2200, in accordance with a version of the invention. At step 2202 a request for a website content is received. The request may be generated by a user of a country where website content may not be accessible. Further method 2200 is divided into 2 sub methods.

At step 2204, it is determined whether, there is a cached copy of website content already available or. If yes, then sub Method-I is followed, if not sub Method-II is followed. Both sub methods may have interdependent steps as well as will be described in detail.

As per sub Method-I, if a cached copy of the website content is available, then at step 2208 it is determined that whether content of the cached copy is consistent with current content of the website content. If the content is consistent with current content, then at step 2212, it is determined that whether translation of the content of the cached copy is correct or not. If translation is determined to be correct, then at step 2216, cached copy of the website content is obtained. At step 2218, this website content is then on an address or URL different from the address or the URL of the website content. Further at step 2220, if after displaying the content, there is any change in content of the website content happens, then that is reflected by making suitable changes.

Now as per sub Method-II if a cached copy of the website content is not available, then at step 2206, content of website content is obtained. This content is then translated at step 2210. Also, in case for step 2212, if cached copy of the website content is not consistent with current content, then as well the sub-Method-I transitions to sub-Method-II to step 2206. Also, if at step 2212, it is determined that translation of cached copy is not correct, sub-Method-I transitions to sub-Method-II to move at step 2210, wherein translation of content is performed. Further, at step 2214 the cache is updated with latest copy of newly translated content. After cache updating, step 2218 and 2220 are performed as disclosed earlier in description.

In another aspect of the present subject matter, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

The invention may also be characterized by the following numbered paragraphs.

A system for automatically acquiring, manipulating and publishing data, system comprising; an input/output module, configured to receive a user query; an intermediary module, communicably connected to the input/output module, wherein the intermediate module comprises; a data fetch module, configured to acquire data from a data source based on the user query; a manipulation module, configured to manipulate the data to better suit user query; and a publication module, configured to publish the manipulated data based on the user query.

The system of paragraph 1, wherein the input/output module is a browser.

The system of paragraph 1, wherein the data is an ecommerce website in a first language.

The system of paragraph 3, wherein the manipulation is anyone or a combination of translation of the ecommerce website from a first language to second language and changing data layout by addition, deletion, or changing of information.

The system of paragraph 4, wherein the publication module supplies layout of the data after translation maintaining the layout analogous to layout of the data.

The system of paragraph 5, wherein the publication of the new layout of translated data is on an address different from corresponding address of the data.

The system of paragraph 6, wherein the address is a uniform resource locator (URL).

A method for automatically acquiring, manipulating and publishing data, method comprising; receiving, by an input/output module, a user query; acquiring, by a data fetch module communicably connected to the input/output module, data based on the user query; manipulating, by a manipulation module, the data acquired to better suit user query; and publishing, by a publication module, the manipulated data based on the user query.

The method of paragraph 8, wherein the input/output module is a browser.

The method of paragraph 8, wherein the data is an ecommerce website in a first language

The method of paragraph 10, wherein the manipulation is anyone or a combination of translation of the ecommerce website from a first language to second language and changing data layout by addition, deletion, or changing of information.

The method of paragraph 11, wherein the publication module supplies layout of the data after translation maintaining the layout analogous to layout of the data.

The method of paragraph 12, wherein the publication of the new layout of translated data is on an address different from corresponding address of the data.

The method of paragraph 13, wherein the address is a uniform resource locator (URL).

A system for automatically translating information comprising; a first server, configured to store information in a first format; a second server, communicably connected to the first server, wherein the second server comprises; an input/output module, configured to display a user input receiving screen to the user to request for the information, wherein the user understands a second format; a hosting module, configured to host the input/output module; and a translation module, communicably connected to the hosting module and configured to receive the user input, wherein the translation module is configured to translate the information from the first format to the second format in real-time based on the user input, wherein further, the layout of the translated information is substantially analogous to the information.

The system of paragraph 15, wherein the translation module further forwards the translated information in analogous layout to the hosting module.

The system of paragraph 16, wherein the analogous layout is hosted by the hosting module to be displayed on the input/output module.

The system of paragraph 15, wherein the information in a first format is not available in a second format before translation.

The system of paragraph 15, wherein the first format and second format are first language and second language.

The system of paragraph 18, wherein the information is a website or a website content.

The system of paragraph 15, wherein the input/output module is a browser.

The system of paragraph 15, wherein the user input is a search query run on a search engine displayed on the browser.

A method for automatically translating information comprising; receiving a user input, on an input screen, to access an information, wherein the information is stored on a first server in a first format; translating, by a translation module, the information to a second format understandable to the user; providing an address, by a hosting module, to the information in second format; and displaying, by the hosting module, the information in second format, wherein layout of the information in second format is substantially analogous to information in first format.

The method of paragraph 23, wherein the information in a first format is not available in a second format before translation.

The method of paragraph 23, wherein the first format and second format are first language and second language.

The method of paragraph 23, wherein the information is an ecommerce website.

A dynamically customizable platform for ecommerce comprising; an ecommerce website, wherein an ecommerce website is hosted on a first server hosted in a first country; a mediation server, wherein the mediation server is communicably connected to the first server, wherein the mediation server is further configured to receive a request for a content, from a user in a second country, present on the ecommerce website, the meditation server further comprising; a translation module, wherein the translation module is configured to translate content of the ecommerce website as and when request is generated by the user to access the ecommerce website; and a hosting module, wherein the hosting module is configured to host the translated content through a local website, wherein address of corresponding local website is different from that of the ecommerce website.

The platform of paragraph 27, wherein the content is product information.

The platform of paragraph 27, wherein the product information is anyone or a combination of anyone of a product name, product details, price, videos, image text, or reviews.

The platform of paragraph 27, wherein the translation is performed to a different language.

The platform of paragraph 27, wherein the address is a uniform resource locator (URL).

The platform of paragraph 27, wherein the local website is analogous to the ecommerce website.

The platform of paragraph 27, wherein the request is generated by typing the address of the ecommerce website on a browser.

A method for dynamically customizing ecommerce comprising; receiving, by a mediation server, a request to access an ecommerce website hosted on a first server in a first country generated from a user in a second country; translating, by a translation module, content of the ecommerce website as and when accessed by the user; hosting, by a hosting module, the translated content of the ecommerce website through an analogous local website, wherein the address of the corresponding website is different from that of the ecommerce website; and displaying, it to the user on a display device.

The method of paragraph 34, wherein the translation is done to a language native to the second country.

The method of paragraph 34, wherein the translation is done real time.

The method of paragraph 34, wherein the content is product information.

The method of paragraph 37, wherein the product information is anyone or a combination of anyone of a product name, product details, price, videos, image text, or reviews.

The method of paragraph 34, wherein the address is a uniform resource locator (URL).

The method of paragraph 34, wherein the request is generated by typing the address of the ecommerce website on a browser.

The method of paragraph 34, wherein the request is generated by searching the ecommerce website on a web search engine.

A system for automated educational purpose, system comprising; a host server, configured to store educational information in a first format; a local server, communicably connected to the host server, configured to publish the educational information, wherein the local server comprises: a caching module, configured to fetch the educational information from the host server and store it as cached educational information; an input/output module, configured to receive a user query; a cache checking module, configured to check consistency between the educational information and the cached educational information, wherein any change done in the educational information is automatically reflected in the cached educational information; and a publication module, configured to publish the cached educational information based on the user query.

The system of paragraph 42, wherein the local server further comprises a hosting module configured to convert the cached educational information to a second format before publication.

The system of paragraph 43, wherein the hosting module publishes the translated cached educational information through an address.

The system of paragraph 44, wherein the address is a uniform resource locator (URL).

The system of paragraph 43, wherein the input/output module is hosted by the hosting module.

The system of paragraph 43, wherein the first format and the second format are a first language and a second language.

The system of paragraph 42, translated cached educational information is displayed in a layout analogous to the educational information on the first server.

A method for automated education comprising; fetching, by a caching module of a local server, an educational information stored in a host server in a first format, communicably connected to the local server, to be stored as cached educational information; checking, by a cache checking module of the local server, consistency between the educational information and the cached educational information, wherein any change done in the educational information is automatically reflected in the cached educational information; and publishing, by a publication module of the local server, the cached educational information based on a user query.

The method of paragraph 49, further comprising displaying an input screen to a user for entering the user query.

The method of paragraph 49, further comprising converting the cached educational information to a second format before publication

The method of paragraph 51, wherein the hosting module publishes the translated cached educational information through an address.

The method of paragraph 52, wherein the address is a uniform resource locator (URL).

The method of paragraph 51, wherein the first format and the second format are a first language and a second language.

A system for automated information publishing comprising; a host server, configured to store information in a first format; a local server, communicably connected to the host server, configured to publish the information, wherein the local server comprises: a caching module, configured to fetch the information from the host server and store it as cached information; an input/output module, configured to receive a user query; a cache checking module, configured to check consistency between the information and the cached information, wherein any change done in the information is automatically reflected in the cached information; and a publication module, configured to publish the cached information based on the user query.

The system of paragraph 55, wherein the local server further comprises a hosting module configured to convert the cached information to a second format before publication.

The system of paragraph 56, wherein the hosting module publishes the translated cached information through an address.

The system of paragraph 57, wherein the address is a uniform resource locator (URL).

The system of paragraph 56, wherein the input/output module is hosted by the hosting module.

The system of paragraph 56, wherein the first format and the second format are a first language and a second language.

The system of paragraph 55, wherein the information is product information.

The system of paragraph 55, wherein the product information is anyone of a product name, product details, price, videos, image text, or reviews.

The system of paragraph 55, translated cached information is displayed in a layout analogous to the information on the first server.

A method for automated information publishing comprising; fetching, by a caching module of a local server, an information stored in a host server in a first format, communicably connected to the local server, to be stored as cached information; checking, by a cache checking module of the local server, consistency between the information and the cached information, wherein any change done in the information is automatically reflected in the cached information; and publishing, by a publication module of the local server, the cached information based on a user query.

The method of paragraph 64, further comprising displaying an input screen to a user for entering the user query.

The method of paragraph 64, further comprising converting the cached information to a second format before publication

The method of paragraph 66, wherein the hosting module publishes the translated cached information through an address.

The method of paragraph 67, wherein the address is a uniform resource locator (URL).

The method of paragraph 67, wherein the first format and the second format are a first language and a second language.

The method of paragraph 64, wherein the information is product information.

The method of paragraph 64, wherein the product information is anyone of a product name, product details, price, videos, image text, or reviews.

A system for automated shopping comprising; a host server, configured to store ecommerce website in a first format; a local server, communicably connected to the host server, configured to publish the ecommerce website, wherein the local server comprises: a caching module, configured to fetch the ecommerce website from the host server and store it as cached ecommerce website; an input/output module, configured to receive a user shopping query; a cache checking module, configured to check consistency between the ecommerce website and the cached ecommerce website, wherein any change done in the ecommerce website is automatically reflected in the cached ecommerce website; and a publication module, configured to publish the cached ecommerce website based on the user shopping query.

The system of paragraph 72, wherein the local server further comprises a hosting module configured to convert the cached ecommerce website to a second format before publication.

The system of paragraph 73, wherein the hosting module publishes the translated cached ecommerce website through an address.

The system of paragraph 74, wherein the address is a uniform resource locator (URL).

The system of paragraph 73, wherein the input/output module is hosted by the hosting module.

The system of paragraph 73, wherein the first format and the second format are a first language and a second language.

The system of paragraph 72, wherein the user shopping query is a product information.

The system of paragraph 72, wherein the product information is anyone of a product name, product details, price, videos, image text, or reviews.

The system of paragraph 72, translated cached ecommerce website is displayed in a layout analogous to the ecommerce website on the first server.

A method for automated information shopping comprising; fetching, by a caching module of a local server, an ecommerce website stored in a host server in a first format, communicably connected to the local server, to be stored as cached ecommerce website; checking, by a cache checking module of the local server, consistency between the ecommerce website and the cached ecommerce website, wherein any change done in the ecommerce website is automatically reflected in the cached ecommerce website; and publishing, by a publication module of the local server, the cached ecommerce website based on a user shopping query.

The method of paragraph 81, further comprising displaying an input screen to a user for entering the user query.

The method of paragraph 81, further comprising converting the cached ecommerce website to a second format before publication

The method of paragraph 83, wherein the hosting module publishes the translated cached ecommerce website through an address.

The method of paragraph 84, wherein the address is a uniform resource locator (URL).

The method of paragraph 83, wherein the first format and the second format are a first language and a second language.

The method of paragraph 81, wherein the user shopping query is product information.

The method of paragraph 81, wherein the product information is anyone of a product name, product details, price, videos, image text, or reviews.

A system for providing products globally comprising; a first server, hosting a main website, comprising information of a plurality of products wherein the information of each of the plurality of products is certified in a first format for a first region; a second server, comprising; a request module, configured to fetch information of at least one product of the plurality of products, based on a user request; a region module, configured to identify region of origin of the user request; a conversion module, configured to convert the information of the at least one product to a second format correspondingly suitable to the region of origin; an intermediary services module, configured to add a plurality of intermediary services to the converted information suitable to the region of origin; and a hosting module, configured to host the converted information on a local website, wherein corresponding address of the local website is different from address of main website and wherein further, the local website address comprises at least a part of the main website address.

The system of paragraph 89, wherein the main website is an ecommerce website.

The system of paragraph 89, wherein the product information is anyone or a combination of a price, shipping information, reviews, availability, and time of arrival.

The system of paragraph 89, wherein the first format and the second format are a first language and a second language respectively.

The system of paragraph 89, wherein the first region and the region of origin are a first country and a second country respectively.

The system of paragraph 89, wherein the plurality of intermediary services includes anyone or a combination of shipment carriers, payment service providers, translation service providers, local sales channel providers, local social networks, or marketing service providers.

The system of paragraph 89, wherein the hosting module further maintains layout of the local website analogous to the main website.

A method for providing products globally comprising; receiving, by a request module, a user request for information about at least one product available in a main website hosted on a first server in a first format for a first region; identifying, by a region module, region of origin of the user request; converting, by a conversion module, the information of the at least one product to a second format correspondingly suitable to the region of origin; adding, by an intermediary services module, a plurality of intermediary services to the converted information suitable to the region of origin; and hosting, by a host module, the converted information on a local website, wherein corresponding address of the local website is different from address of main website and wherein further, the local website address comprises at least a part of the main website address.

The method of paragraph 96, wherein the main website is an ecommerce website.

The method of paragraph 96, wherein the product information is anyone or a combination of a price, shipping information, reviews, availability, and time of arrival.

The method of paragraph 96, wherein the first format and the second format are a first language and a second language respectively.

The method of paragraph 96, wherein the first region and the region of origin are a first country and a second country respectively.

The method of paragraph 96, wherein the plurality of intermediary services includes anyone or a combination of shipment carriers, payment service providers, translation service providers, local sales channel providers, local social networks, or marketing service providers.

The method of paragraph 96, further comprises maintaining layout of the local website analogous to the main website.

A system for providing reseller website services comprising; a first server, hosting a main website, for a first region in a first format, a second server, hosting a reseller website, wherein the reseller website is configured to host the main website after performing steps of: acquiring latest copy of the main website from the first server; translating, the latest copy into a second format suitable for a second region, adding, the reseller website services suitable for the second region, to the translated latest copy to create a copy website; and hosting the copy website on an address different from a corresponding address of the main website.

The system of paragraph 103, wherein the main website is an ecommerce website.

The system of paragraph 103, wherein the first format and the second format are a first language, and a second language respectively.

The system of paragraph 103, wherein the first region and the second region are a first country and a second country respectively.

The system of paragraph 103, wherein the reseller website services are anyone or a combination of shipping carriers, payment services, sales channels, social networks, and marketing service providers.

The system of paragraph 103, wherein the address is a uniform resource locator (URL).

The system of paragraph 108, wherein the URL of the copy website includes an indication of the main website.

A method for providing reseller website services comprising; acquiring, by a local server, latest copy of a main website of a first region in a first format from a first server; translating, by the second server, latest copy of the main website from the first server, adding, the reseller website services suitable for a second region, to the translated latest copy to create a copy website; and hosting the copy website on an address different from a corresponding address of the main website.

The method of paragraph 110, further comprising maintaining layout of the copy website analogous to the main website.

The method of paragraph 110, wherein the main website is an ecommerce website.

The method of paragraph 110, wherein the first format and the second format are a first language, and a second language respectively.

The method of paragraph 110, wherein the first region and the second region are a first country and a second country respectively.

The method of paragraph 110, wherein the reseller website services are anyone or a combination of shipping carriers, payment services, sales channels, social networks, and marketing service providers.

The method of paragraph 110, wherein the address is a uniform resource locator (URL).

The method of paragraph 116, wherein the URL of the copy website includes an indication of the main website.

A system for providing intermediary website services, the system comprising; a first server, configured to host a website in a first format for a first region; a second server, communicably connected to the first server, configured to host a local website for second region, wherein the second server is further configured to translate information of the website into a second format suitable for the second region, wherein the layout of the translated information is analogous to the website layout; and an intermediary server, communicably connected to the second server, configured to provide intermediary website services specific to the second region.

The system of paragraph 118, wherein the first region and the second regions are a first country and a second country.

The system of paragraph 118, wherein the first format and the second format are a first language and a second language.

The system of paragraph 118, wherein the first server and the second server provide hosting for different countries.

The system of paragraph 118, wherein the website is an ecommerce website.

The system of paragraph 122, wherein the information is product information present on the ecommerce website.

The system of paragraph 118, wherein the intermediary services are anyone or a combination of shipment carriers, payment service providers, translation service providers, local sales channel providers, local social networks, or marketing service providers.

A method for providing intermediary website services, method comprising; accessing, a website hosted on a first server including information in a first format for a first region; converting, the information into a second format understandable by a user of a second region, wherein the conversion is performed by providing intermediary website services wherein the intermediary services comprises any one or a combination of shipment carriers, payment service providers, translation service providers, local sales channel providers, local social networks, or marketing service providers.

The method of paragraph 125, wherein first format and the second format are a first language and a second language.

The method of paragraph 125, wherein the first server and the second server provide hosting for different countries.

The method of paragraph 125, wherein the website is an ecommerce website.

The method of paragraph 125, wherein the information is product information present on the ecommerce website

A method for ecommerce comprising; receiving, by an intermediary server, a request for at least one product not available in a country, analyzing, by the intermediary server, the request; identifying, by the intermediary server, a certified source website of the product based on the request; fetching, by the intermediary server, a copy of the source website; translating, by the intermediary server, information in the copy of the source website to a language suitable for the country; initiating, by the intermediary server, a delivery auction process for delivery information of the at least one product comprising steps of; sending information to affiliate delivery providers; identifying best bids; selecting a best bid for the delivery information; and displaying, by the intermediary server, the copy of the source website along with the selected bid for delivery information.

The method of paragraph 130, wherein the copy of the source website is hosted on an address different that address of source website.

The method of paragraph 130, wherein the address is a uniform resource locator (URL).

The method of paragraph 130, wherein the URL of the copy of the source website contains at least a part of the URL of the source website.

The method of paragraph 130, wherein the affiliate delivery providers are indigenous delivery providers.

The method of paragraph 130, wherein the source website is hosted in a language not widely understood in the country.

The method of paragraph 130, wherein the best bid is identified based on anyone or combination of number of days to be taken to delivery, costs of delivery, reviews for the delivery providers, and time to respond to the auction process.

The method of paragraph 130, wherein the request is generated by a wholesale seller, a retail seller, or an individual buyer.

The method of paragraph 130, wherein layout of the copy of the source website is analogous to the source website.

The method of paragraph 130, wherein the information in the copy of the source website is displayed as certified.

A sourcing ecommerce method comprising; receiving, by an intermediary server, a user request for at least one product not available in a country, analyzing, by the intermediary server, the request; identifying, by the intermediary server, a certified source website of the product based on user's request; fetching, by the intermediary server, a copy of the source website; translating, by the intermediary server, information in the copy of the source website to a language suitable for the country; initiating, by the intermediary server, a delivery auction process for delivery information of the at least one product comprising steps of; sending information to affiliate delivery providers; identifying best bids; selecting a best bid for the delivery information; receiving, by the intermediary server, an order for the at least one product; sending, by the intermediary server, the order fulfillment request to the source website; receiving, by the intermediary server, order delivery details from the source website to an address different from the address of the user, wherein the delivery address corresponds to the affiliate delivery provider with the best bid; and providing, by the intermediary server, a delivery schedule after consideration of the delivery details received from the source website; and displaying, by the intermediary server, the copy of the source website along with the delivery information.

The method of paragraph 140, wherein the copy of the source website is hosted on an address different that address of source website.

The method of paragraph 140, wherein the address is a uniform resource locator (URL).

The method of paragraph 140, wherein the URL of the copy of the source website contains at least a part of the URL of the source website.

The method of paragraph 140, wherein the affiliate delivery providers are indigenous delivery providers.

The method of paragraph 140, wherein the source website is hosted in a language not widely understood in the country.

The method of paragraph 140, wherein the best bid is identified based on anyone or combination of number of days to be taken to delivery, costs of delivery, reviews for the delivery providers, and time to respond to the auction process.

The method of paragraph 140, wherein layout of the copy of the source website is analogous to the source website.

The method of paragraph 140, wherein the information in the copy of the source website is displayed as certified.

A system for localizing a website, comprising; a main web server, wherein the server is configured to host a main website; a local server, wherein the local server is for a geographically different area that the main web server, the local server comprising; a translation module, wherein the translation module is configured to translate content of the main website in a language suitable for local area, in real-time; a host module, wherein the host module is configured to host the translated content through a local website, wherein address of corresponding local website is different from of the main website; and a change check module, wherein the change check module is configured to check if there are any changes on the main website and replicates those changes to the local website.

The system for localizing a website of paragraph 149, wherein the main web server and the local server are placed together.

The system for localizing a website of paragraph 149, wherein the main web server and the local server are placed remotely to each other.

The system for localizing a website of paragraph 149, wherein the geographically different area is a different country.

The system for localizing a website of paragraph 149, wherein the language is a locally spoken/understood language.

The system for localizing a website of paragraph 149, wherein the address is a uniform resource locator (URL).

The system for localizing a website of paragraph 149, wherein the content is information about a product.

The system for localizing a website of paragraph 155, wherein the information is anyone or a combination of a product name, product details, price, videos, image text, or reviews.

A method for localizing a website, comprising; obtaining content of the website, wherein the website is hosted on a main server by a first address; translating, the content obtained from the website, into a language specific to a geographical area, hosting, the translated content analogous to the content of the website, wherein the hosting is performed by a local server by a second address, wherein the second address is different from the first address; and displaying, the translated content to a user of the specific geographical area.

The method of paragraph 157, wherein the content is information about a product.

The method of paragraph 158, wherein the information is anyone or a combination of a product name, product details, price, videos, image text, or reviews.

The method of paragraph 157, wherein first and second addresses for hosting are uniform resource locators (URLs)

The method of paragraph 157, wherein the translation of content is performed real-time.

The method of paragraph 157, further comprises making changes to translated website content whenever there are changes in the website content.

The method of paragraph 157, wherein the main server and the local sever are placed together.

The method of paragraph 157, wherein the main server and the local server are placed remotely to each other.

The method of paragraph 157, wherein the specific geographical area is a different country having different language.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following paragraphs particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed is:

1. A system for automatically acquiring, manipulating and publishing data, the system comprising;
an input/output module, configured to receive a user query;
an intermediary module, communicably connected to the input/output module, wherein the intermediate module comprises;
a data fetch module, configured to acquire data from a data source based on the user query;
a manipulation module, configured to manipulate the data to better suit user query; and
a publication module, configured to publish the manipulated data based on the user query.

2. The system of claim 1, wherein the input/output module is a browser.

3. The system of claim 1, wherein the data is an ecommerce website in a first language.

4. The system of claim 3, wherein the manipulation is a combination of translating the ecommerce website from a first language to second language and changing the data layout by addition, deletion, or changing the data.

5. The system of claim 4, wherein the publication module supplies layout of the data after translation and maintains the layout analogous to layout of the data.

6. The system of claim 5, wherein the publication of the new layout of translated data is at an address different from corresponding address of the data.

7. The system of claim 6, wherein the address is a uniform resource locator (URL).

8. A method for automatically acquiring, manipulating and publishing data, the method comprising;
receiving, by an input/output module, a user query;
acquiring, by a data fetch module communicably connected to the input/output module, data based on the user query;
manipulating, by a manipulation module, the data acquired to better suit user query; and
publishing, by a publication module, the manipulated data based on the user query.

9. The method of claim 8, wherein the input/output module is a browser.

10. The method of claim 8, wherein the data is an ecommerce website in a first language.

11. The method of claim 10, wherein the manipulation is a combination of translating the ecommerce website from a first language to second language and changing data layout by addition, deletion, or changing of the data.

12. The method of claim 11, wherein the publication module supplies layout of the data after translation and maintains the layout analogous to layout of the data.

13. The method of claim 12, wherein the publication of the new layout of translated data is at an address different from corresponding address of the data.

14. The method of claim 13, wherein the address is a uniform resource locator (URL).
